(19) United States
(12) Patent Application Publication
(10) Pub. No.: US 2006/0186671 A1
(43) Pub. Date: Aug. 24, 2006

(54) Submerged turbine generator

(75) Inventors: Shuichiro Honda, Tokyo (JP); Masao Matsumura, Tokyo (JP)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: Ebara Corporation

(21) Appl. No.: 11/349,629

(22) Filed: Feb. 7, 2006

(30) Foreign Application Priority Data
Feb. 18, 2005 (JP) 2005-043140

(51) Int. Cl. F03B 13/00

(52) U.S. Cl. 290/54

(57) ABSTRACT

A submerged turbine generator is operated by a working fluid, such as liquid nitrogen, liquefied natural gas, or liquid ethylene, to generate electric power. The submerged turbine generator includes a shaft, a casing, a turbine having a runner fixed to the shaft, a generator having a rotor fixed to the shaft and a stator surrounding the rotor, and bearings for rotatably supporting the shaft. The runner is rotated integrally with the shaft by the pressure of the working fluid introduced into the casing. The shaft includes at least two members.

### BACKGROUND OF THE INVENTION

1. Field of the Invention

The present invention relates to a submerged turbine generator, and more particularly to a submerged turbine generator which is operated by a working fluid selected in advance.

2. Description of the Related Art

There has been known a submerged turbine generator comprising a turbine and a generator. Generally, a low-temperature fluid having a high pressure, such as liquid nitrogen, liquefied natural gas, or liquid ethylene, is used as a working fluid to rotate the turbine. The torque of the turbine rotates a rotor of the generator to thereby generate electric power. The generator is submerged in the working fluid (i.e., the low-temperature fluid) so as to be cooled by the working fluid.

This type of submerged turbine generator generally comprises a turbine fixed to a shaft, a generator having a rotor and a stator, and a housing in which the generator is housed. The housing is accommodated in a casing so that a main passage for the working fluid is formed between the housing and the casing. The turbine has a runner rotated by a fluid pressure of a working fluid introduced into the casing. The rotor of the generator is fixed to the shaft and is thus rotatable together with the shaft. The stator is disposed so as to surround the rotor. The runner is rotated integrally with the shaft and the rotor by the fluid pressure of the working fluid flowing through the runner. During operation, a part of the working fluid flowing into the runner is introduced into the casing to thereby cool the generator. An example of the submerged turbine generator is disclosed in U.S. Pat. No. 5,659,205 and Japanese laid-open patent publication No. H10-9114.

However, the conventional submerged turbine generator has several drawbacks including the short service life, the high price, and the insufficient generation efficiency. Thus, there is room for improvement in the conventional submerged turbine generator. Additionally, this type of submerged turbine generator generally has a complicated thrust balancing mechanism for balancing the thrust load (i.e., the axial force) applied to the shaft during operation. Thus, there is a need to simplify or eliminate such a complicated thrust balancing mechanism.

### SUMMARY OF THE INVENTION

The present invention has been made in view of the above drawbacks. It is therefore an object of the present invention to provide a submerged turbine generator which has advantages including a longer service life, a lower price, and an improved generation efficiency and can meet the need to simplify or eliminate the thrust balancing mechanism.

In order to solve the above drawbacks, according to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, and bearings for rotatably supporting the shaft. The shaft includes at least two members.

Generally, the shaft has a portion to which the runner is fixed. This portion is required to have as small a diameter as possible within permissible limits of strength in order to increase an area of the outlet of the runner. Further, in order to improve performance of the generator, a portion of the shaft to which the rotor is fixed should preferably be made of a magnetic material. However, a low-priced material having both magnetic properties and high strength is not easily available. Further, it is generally difficult to work a long single piece of material to form the shaft. According to the present invention, the combination of at least two members can provide the shaft having magnetic properties and high strength.

In a preferred aspect of the present invention, the at least two members of the shaft comprise a generator-side shaft to which the rotor is fixed, and a turbine-side shaft to which the runner is fixed. The generator-side shaft and the turbine-side shaft are coupled to each other in series.

According to the present invention, for example, the generator-side shaft can be made of a high strength material and the turbine-side shaft can be made of a magnetic material. Accordingly, the turbine generator having excellent strength and excellent magnetic properties can be provided. Furthermore, a length of the generator-side shaft and the turbine-side shaft can be short compared with a shaft formed from a single member. Therefore, workability can be improved.

In a preferred aspect of the present invention, the at least two members of the shaft comprise a solid shaft, and a sleeve shaft surrounding the solid shaft. The rotor is fixed to an outer circumferential surface of the sleeve shaft, and the runner is fixed to a circumferential surface of the solid shaft.

Generally, the diameter of a portion of the shaft to which the rotor is fixed is determined by a punch die used for a rotor core. This diameter is about 1.5 to 3 times the diameter of a portion of a shaft to which a runner is fixed. Therefore, the double structure comprising the solid shaft and the sleeve shaft contributes to easy production of the shaft having a diameter suitable for the rotor and a diameter suitable for the runner. Further, the combination of the solid shaft made of a high-strength material and the sleeve shaft made of a magnetic material can optimize qualities of the shaft which requires high strength and magnetic properties. Therefore, the turbine generator having excellent strength and excellent magnetic properties can be provided. Furthermore, because a maximum diameter of the solid shaft can be very small, a diameter of a raw material can be small, and therefore a cutting amount and a load on the environment can be reduced.

According to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, a thrust balancing mechanism operable to balance a thrust load applied to the shaft, and bearings for rotatably supporting the shaft. At least one of the bearings comprises a thrust magnetic bearing operable to support the thrust load applied to the shaft at rest and start-up.

The thrust balancing mechanism serves to cancel the thrust load only during normal operation. Consequently, the thrust load is applied to the thrust bearing at start-up for a short time. Under such situations, if a single-row deep-groove ball bearing is used to support the thrust load, the life of the turbine generator as a whole may be shortened because the single-row deep-groove ball bearing generally has a poor capability of supporting the thrust load. Generally, a magnetic bearing has a low ratio of a supporting capability to its volume. Accordingly, if the magnetic bearing is used to support the thrust load during normal operation, the bearing itself becomes very large in size. According to the present invention, the thrust magnetic bearing serves to support the thrust load at rest and start-up, and the thrust balancing mechanism serves to support the thrust load during normal operation, so that the thrust magnetic bearing can support the thrust load at rest and start-up and the thrust balancing mechanism can cancel the thrust load during normal operation.

The thrust magnetic bearing covers a range from a resting state to a low rotational speed at which the thrust balancing mechanism does not properly function. In this range, a dynamic thrust load caused mainly by the turbine differential pressure is small, and a static thrust load is smaller than the weight of the rotor. Therefore, the thrust magnetic bearing can be smaller in size than a magnetic bearing for normal operation. A target position of the rotor controlled by the thrust magnetic bearing is set equal to an axial position of the rotor determined by the operation of the thrust balancing mechanism, whereby an unwanted moving force is prevented from being produced in the thrust magnetic bearing during normal operation.

According to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, and bearings for rotatably supporting the shaft. Each of the bearings comprises a contact bearing section and a non-contact bearing section.

In the submerged turbine generator, the working fluid is used to lubricate the bearings. Generally, the working fluid has a low lubricating capability, and therefore the bearings should be replaced at regular time intervals. According to the present invention, the contact bearing sections can be used to support the shaft only at rest and start-up. Therefore, the contact bearing sections can have a longer life than that of the submerged turbine generator as a whole. Further, during normal operation, the shaft can be supported by the non-contact bearing sections, which are hydrostatic bearings utilizing the turbine differential pressure or hybrid bearings utilizing both static pressure and dynamic pressure. Therefore, it is possible to prevent contact problems from occurring due to lack of differential pressure at low speed operation such as at start-up.

According to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, bearings for rotatably supporting the shaft, a main line through which a working fluid is delivered to the runner, and a secondary line through which the working fluid is delivered to cool the bearings.

In the case of using a non-contact bearing such as a hydrostatic bearing or a hybrid bearing, the high-pressure working fluid can be supplied to the bearings through the secondary line before starting the turbine, thus allowing the bearings to have a supporting capability. Accordingly, the bearings can be kept out of contact with the shaft at all times, i.e., during resting state, operating state, and stop state. Therefore a maintenance-free turbine generator can be provided. The bearings may be a dynamic-pressure bearing, such as a foil bearing, or a ball bearing. In this case also, before starting the turbine, the high-pressure working fluid can be supplied to the bearings through the secondary line, resulting in improved lubricating and cooling effects and a longer life.

According to one aspect of the present invention, there is provided a submerged turbine generator comprising a shaft, a casing, a turbine having a runner fixed to a first end of the shaft so that the runner is rotated integrally with the shaft due to pressure of a working fluid introduced into the casing, a generator having a rotor fixed to the shaft and a stator surrounding the rotor; a thrust balancing mechanism operable to balance a thrust load applied to the shaft, and bearings for rotatably supporting the shaft. The thrust balancing mechanism comprises a fixed orifice and a variable orifice. The fixed orifice and/or the variable orifice is disposed at a second end of the shaft opposite to the first end.

After the working fluid passes through the fixed orifice and the variable orifice of the thrust balancing mechanism, the pressure of the working fluid is reduced. If the working fluid having a reduced pressure is used to cool the bearings, such working fluid may be evaporated during cooling of the bearing. Evaporation of the working fluid flowing through the bearings may result in damage to the bearing. According to the present invention, because the fixed orifice and/or the variable orifice are disposed at the second end of the shaft opposite to the first end to which the runner is fixed, the working fluid can be supplied to the bearings before passing through the thrust balancing mechanism. Therefore, the high-pressure working fluid, which is not likely to be evaporated, can be used to cool the bearings, thus preventing damage to the bearings due to cooling failure.

According to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, a housing in which the generator is housed, a thrust balancing mechanism operable to balance a thrust load applied to the shaft, and bearings for rotatably supporting the shaft. The thrust balancing mechanism comprises a balance sleeve fixed to the shaft and arranged to form a fixed orifice and/or a variable orifice with the housing.

Generally, the thrust balancing mechanism serves to balance the thrust load by utilizing the thrust force generated due to the diameter difference between two wearing rings and by utilizing the fluid pressure in a variable pressure chamber formed between the variable orifice and the fixed orifice. Accordingly, the runner disposed at the side of the thrust balancing mechanism requires two wearing rings. This means that a multistage turbine requires two types of runners: one having a single wearing ring, and the other having two wearing rings. This also means that two types of casting patterns should be prepared to manufacture the multistage turbine. According to the present invention, by providing a fixed orifice and/or a variable orifice of the thrust balancing mechanism between the housing and the balance sleeve fixed to the shaft, only one type of runner is required in manufacturing the multistage turbine.

In a preferred aspect of the present invention, both a fixed orifice and a variable orifice are formed between the balance sleeve and the housing.

In a preferred aspect of the present invention, the thrust balancing mechanism has a variable orifice located between the shaft and the housing.

In a preferred aspect of the present invention, the thrust balancing mechanism has a variable orifice located between the runner and the housing.

According to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, a thrust balancing mechanism operable to balance a thrust load applied to the shaft, and bearings for rotatably supporting the shaft. The thrust balancing mechanism comprises a balance piston fixed to the shaft.

The balance piston has a predetermined diameter such that a force is generated to counteract the thrust load at specific operating point and reduce the thrust load during normal operation. In this embodiment, the balance piston constitutes the thrust balancing mechanism for specific operation point.

The use of the balance piston, which has a predetermined diameter such that a force is generated to counteract the thrust load during normal operation, can increase the life of the bearings by canceling or reducing the thrust load during normal operation, and can simplify the structure of both the single-stage turbine generator and the multistage turbine generator having a plurality of turbine stages arranged in series facing the same direction.

According to one aspect of the present invention, there is provided a submerged turbine generator comprising a shaft, a casing, a multistage turbine having a plurality of runners fixed to the shaft so that the runners are rotated integrally with the shaft due to pressure of a working fluid introduced into the casing, a generator having a rotor fixed to the shaft and a stator surrounding the rotor, and bearings for rotatably supporting the shaft. The multistage turbine comprises a first turbine group and a second turbine group which are arranged so as to face opposite directions.

Generally, in a multistage turbine having a plurality of turbine stages facing the same direction, a force is produced due to an axial fluid force and a fluid pressure. This force acts as a thrust load to increase the load exerted on the bearings. According to the present invention, the opposed multistage turbine groups, each having the same number of stages, can cancel the thrust load generated in the turbine generator. For example, if the multistage turbine has six stages, it comprises three turbine stages facing one direction, and three turbine stages facing the opposite direction. In the horizontal turbine generator, the arrangement of the opposed multistage turbine groups can completely cancel the thrust load. In the vertical turbine generator, in order to generate an upward force corresponding to the weight of the rotating assembly (i.e., the shaft, the rotor, and the runners) during normal operation, the number of upwardly facing runners (i.e., the runners having the upwardly facing outlets) may be appropriately increased, and/or the diameter of the wearing rings may be adjusted. By appropriately adjusting the number of upwardly facing runners and/or the diameter of the wearing rings, the thrust load can be cancelled during normal operation, and hence the life of the bearings can increase.

According to one aspect of the present invention, there is provided a submerged turbine generator comprising a shaft, a casing, a plurality of turbine stages each having a runner fixed to the shaft so that the runner of each of the plurality of turbine stages is rotated integrally with the shaft due to pressure of a working fluid introduced into the casing, a generator having a rotor fixed to the shaft and a stator surrounding the rotor, and bearings for rotatably supporting the shaft. The plurality of turbine stages comprise a first turbine group and a second turbine group which are arranged so as to face opposite directions. The first turbine group and the second turbine group are arranged so as to simultaneously receive the working fluid to thereby simultaneously rotate the plurality of turbine stages. The first turbine group and the second turbine group may be arranged so that the generator is interposed therebetween.

Generally, a runaway speed is determined by the shape of a path formed in the runner. According to the present invention, a flow rate can be doubled while maintaining the shape of the path of the runner as it is. Specifically, the flow rate can be doubled while the runaway speed is kept low. Accordingly, it is possible to provide a high flow rate submerged turbine generator which is safe in terms of the centrifugal stress. Further, according to the present invention, the axial fluid force can be cancelled.

In a preferred aspect of the present invention, the plurality of turbine stages are shaped and arranged so as to allow the working fluid to form two flows moving in opposite directions to thereby simultaneously rotate said plurality of turbine stages. The first turbine group and the second turbine group may be arranged so that the generator is interposed therebetween.

According to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, and a housing in which the generator is housed. The housing has bearings for rotatably supporting the shaft. The housing has a cooling liquid inlet through which a part of the working fluid in the casing is introduced into the housing.

If the low-pressure working fluid is introduced into the housing so as to cool the generator housed in the housing, the low-pressure working fluid is likely to be evaporated due to heat loss of the generator, resulting in insufficient cooling of the generator. According to the present invention, because a part of the high-pressure working fluid is introduced into the housing to cool the generator, the working fluid is hardly evaporated and can thus sufficiently cool the generator. In order to prevent foreign materials from entering the housing, a filter may be attached to the cooling liquid inlet.

According to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, a housing in which the generator is housed, a main line through which the working fluid is delivered into the casing; and a secondary line through which the working fluid is delivered into the housing. The housing has bearings for rotatably supporting the shaft.

Generally, if the working fluid passes through the turbine and then flows into the housing, foreign materials may enter the housing. According to the present invention, the secondary line is provided separately from the main line so that the working fluid is independently delivered to the housing. Therefore, the foreign materials can be prevented from entering the housing. In this case, it is preferable to provide a filter or a strainer in the secondary line so as to effectively prevent the foreign materials from entering the housing. Further, according to the present invention, because the high-pressure working fluid is introduced into the housing, an internal pressure of the housing increases to such a degree that the working fluid is hardly evaporated. The secondary line may serve as both a cooling line and a bearing lubrication line. Specifically, the working fluid may lubricate the bearings and then cool the generator. The reverse is also possible. The working fluid may be supplied to the sides of coil ends of the stator.

According to one aspect of the present invention, there is provided a submerged turbine generator comprising a shaft, a turbine having a runner fixed to the shaft so that the runner is rotated integrally with the shaft due to pressure of a working fluid, a generator having a rotor fixed to the shaft and a stator surrounding the rotor, and bearings for rotatably supporting the shaft. The generator is housed in the housing. The working fluid is supplied into the housing, flows around the generator, and then rotates the runner.

If the working fluid having a low pressure is introduced into the housing so as to cool the generator, the low-pressure working fluid is likely to be evaporated due to heat loss of the generator, resulting in insufficient cooling of the generator. According to the present invention, because the high-pressure working fluid (turbine inlet flow) is introduced into the housing so as to cool the generator, the working fluid is hardly evaporated in the housing and can thus sufficiently cool the generator. Further, because all of the working fluid used to rotate the turbine flows around the generator, an average temperature of the working fluid does not increase to so high a level, and hence the working fluid can be further prevented from being evaporated in the housing.

From a viewpoint of cooling effect and manufacturing efficiency, the channels in the housing are preferably provided inside the stator or on the outer circumferential surface of the stator in the axial direction of the shaft. In terms of strength, the channels should preferably have a substantially circular cross section. On the other hand, in terms of cooling effect, the channels should preferably have a rectangular, triangular, or star-shaped cross section, which has a long wetted perimeter. A filter may be attached to a fluid inlet in order to prevent the foreign materials from entering the housing.

If a differential pressure is created in the axial direction of the shaft, thrust force is generated, which is not preferable. Therefore, it is preferable to provide a relief line in order for a pressure at the turbine-inlet-side end portion of the shaft to approach an outlet pressure. Additionally, in order to further reduce the pressure at the turbine-inlet-side end of the shaft, it is preferable to provide a bush-like annular ring upstream or downstream of the turbine-inlet-side bearing.

In a preferred aspect of the present invention, the submerged turbine generator further comprises a coil end cover surrounding a coil end of the stator.

The coil end cover, surrounding the coil end of the stator, can protect the coil end from being exposed to the flow of the working fluid, thus preventing damage to the coil end.

In a preferred aspect of the present invention, a plurality of stays are provided on an outer circumferential surface of the coil end cover.

The stays can condition the flow of the working fluid running along the outer circumferential surface of the coil end cover.

According to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, and bearings for rotatably supporting the shaft. The runner has a single inlet, a first outlet, and a second outlet to allow the working fluid to form two flows moving away from each other along an axial direction of the shaft.

Generally, a centrifugal runner has a low runaway speed compared with a mixed flow type and an axial flow type during non-road running, and is advantageous in reducing centrifugal stress. However, if the centrifugal runner is designed to deliver a fluid at a high flow rate, the shape of the runner should be of the mixed flow type. Therefore, there is a limit in increasing the flow rate under the condition of the reduced centrifugal stress. According to the present invention, because the runner has the single inlet and the first and second outlets through which the working fluid is discharged to form the two flows moving away from each other along the axial direction of the shaft, the flow rate can be doubled while maintaining the shape of the path of the runner, which determines the runaway speed, as it is. Specifically, the flow rate can be doubled while the runaway speed is kept low. Accordingly, it is possible to provide a high flow rate submerged turbine generator which is safe in terms of the centrifugal stress. Further, according to the present invention, the axial fluid force can be cancelled. Furthermore, in the vertical turbine generator, the diameter of the wearing rings near the first and second outlets may be adjusted so as to generate axial fluid force which can cancel the weight of the rotor. By appropriately adjusting the diameter of the wearing rings, the thrust load can be balanced during design speed operation, whereby the life of the bearings can increase.

According to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, bearings for rotatably supporting the shaft, and a radial nozzle disposed near peripheral inlets of the runner.

In some turbine generators, an axial nozzle is disposed upstream of the runner so as to lead the working fluid to the runner. However, with this configuration, the inlets of the runner and the outlets of the axial nozzle should be spaced from each other by a certain distance, and the working fluid flowing through a path between the runner and the axial nozzle is forced to turn at a substantially right angle. Such arrangements and a change in the flowing direction impose a limit on the turbine performance. According to the present invention, the working fluid in the radial nozzle can form a straight meridional flow running radially, and a distance between the outlets of the radial nozzle and the inlets of the runner can be set short. Accordingly, the runner can receive energy of the flow from the radial nozzle with a minimal loss. Therefore, the turbine performance can be improved.

According to one aspect of the present invention, there is provided a submerged turbine generator comprising a shaft, a casing, a turbine having a runner fixed to the shaft so that the runner is rotated integrally with the shaft due to pressure of a working fluid introduced into the casing, a generator having a rotor fixed to the shaft and a stator surrounding the rotor, bearings for rotatably supporting the shaft, and a multiple volute nozzle disposed near peripheral inlets of the runner.

The multiple volute nozzle can also allow the working fluid in the radial direction to form a straight meridional flow running radially. Further, a distance between the outlets of the multiple volute nozzle and the inlets of the runner can be set short. Accordingly, the runner can receive energy of the flow from the multiple volute nozzle with a minimal loss. Therefore, the turbine performance can be improved. Further, since the multiple volute nozzle has a plurality of volute channels, a radial fluid force becomes smaller than a single volute nozzle.

As described above, the present invention can provide the submerged turbine generator which has advantages including a longer service life, a lower price, and an improved generation efficiency and can meet the need to simplify or eliminate the thrust balancing mechanism.

### BRIEF DESCRIPTION OF THE DRAWINGS

FIG. 1 is a cross-sectional view showing a submerged turbine generator according to an embodiment of the present invention;

FIG. 2 is an enlarged view showing an essential part shown in FIG. 1;

FIG. 3 is a view showing divided surfaces of a shaft used in the submerged turbine generator shown in FIG. 1;

FIG. 4 is a view showing a coupling section of the shaft used in the submerged turbine generator shown in FIG. 1;

FIG. 5 is a view showing another example of the shaft;

FIG. 6 is a local cross-sectional view showing a submerged turbine generator according to another embodiment of the present invention;

FIG. 7 is a cross-sectional view showing a submerged turbine generator according to still another embodiment of the present invention;

FIG. 8 is an enlarged view showing an upper bearing of the submerged turbine generator shown in FIG. 7;

FIG. 9 is an enlarged view showing a lower bearing of the submerged turbine generator shown in FIG. 7;

FIG. 10 is a cross-sectional view showing a hydrostatic bearing of the submerged turbine generator shown in FIG. 7;

FIG. 11 is a view showing an essential part of a modified example of the submerged turbine generator shown in FIG. 7;

FIG. 12 is a cross-sectional view showing a submerged turbine generator according to still another embodiment of the present invention;

FIG. 13 is a cross-sectional view showing a hydrostatic bearing of the submerged turbine generator shown in FIG. 12

FIG. 14 is a cross-sectional view showing a submerged turbine generator according to still another embodiment of the present invention;

FIG. 15 is a cross-sectional view showing a submerged turbine generator according to still another embodiment of the present invention;

FIG. 16 is a cross-sectional view showing a submerged turbine generator according to still another embodiment of the present invention;

FIG. 17 is a cross-sectional view showing a submerged turbine generator according to still another embodiment of the present invention;

FIG. 18 is a cross-sectional view showing a submerged turbine generator according to still another embodiment of the present invention;

FIG. 19 is a cross-sectional view showing a submerged turbine generator according to still another embodiment of the present invention;

FIG. 20 is a cross-sectional view showing an essential part of a submerged turbine generator according to still another embodiment of the present invention;

FIG. 21 is a schematic view showing a radial nozzle;

FIG. 22 is an enlarged view showing the radial nozzle attached to the submerged turbine generator;

FIG. 23 is a schematic view showing a multiple volute nozzle;

FIG. 24 is a cross-sectional view showing a submerged turbine generator according to still another embodiment of the present invention;

FIG. 25 is a cross-sectional view showing an essential part of a modified example of the submerged turbine generator shown in FIG. 24;

FIGS. 26A and 26B are schematic views showing modified examples of the submerged turbine generator shown in FIG. 24;

FIGS. 27 A and 27B are schematic views showing modified examples of the submerged turbine generator shown in FIG. 24;

FIGS. 28A and 28B are schematic views showing submerged turbine generators according to still another embodiment of the present invention;

FIG. 29 is a cross-sectional view showing a submerged turbine generator according to still another embodiment of the present invention;

FIG. 30 is a cross-sectional view showing a submerged turbine generator according to still another embodiment of the present invention;

FIG. 31 is a cross-sectional view showing a modified example of the submerged turbine generator shown in FIG. 30;

FIG. 32 is a cross-sectional view showing a submerged turbine generator according to still another embodiment of the present invention;

FIG. 33 is a cross-sectional view showing a submerged turbine generator according to still another embodiment of the present invention;

FIG. 34 is a cross-sectional view showing a submerged turbine generator according to still another embodiment of the present invention; and

FIG. 35 is a perspective view showing a coil cover end and stays of the submerged turbine generator shown in FIG. 34.

### DETAILED DESCRIPTION OF THE PREFERRED EMBODIMENTS

Embodiments of the present invention will be described in detail below with reference to the drawings.

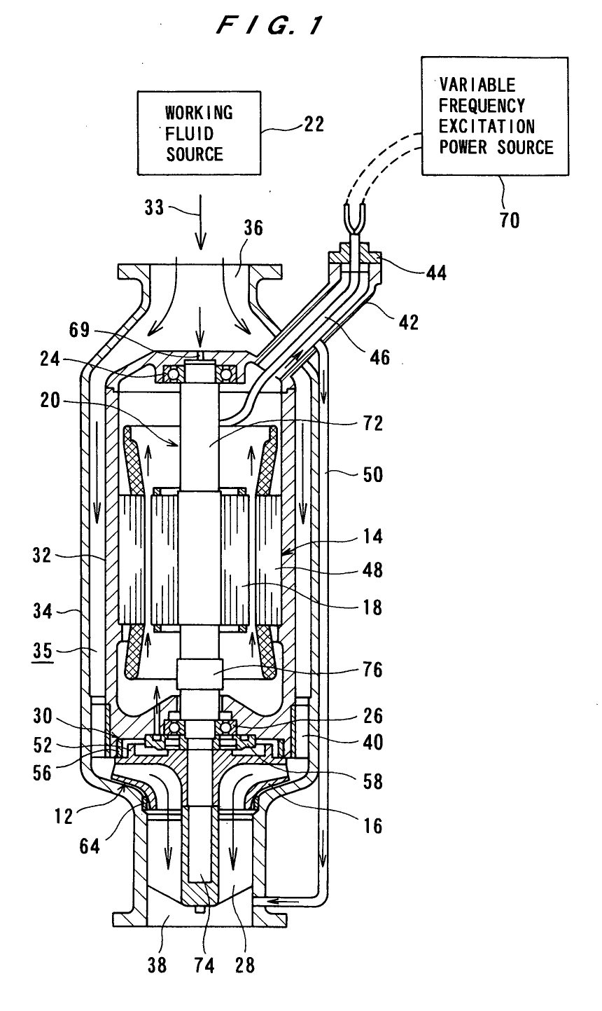

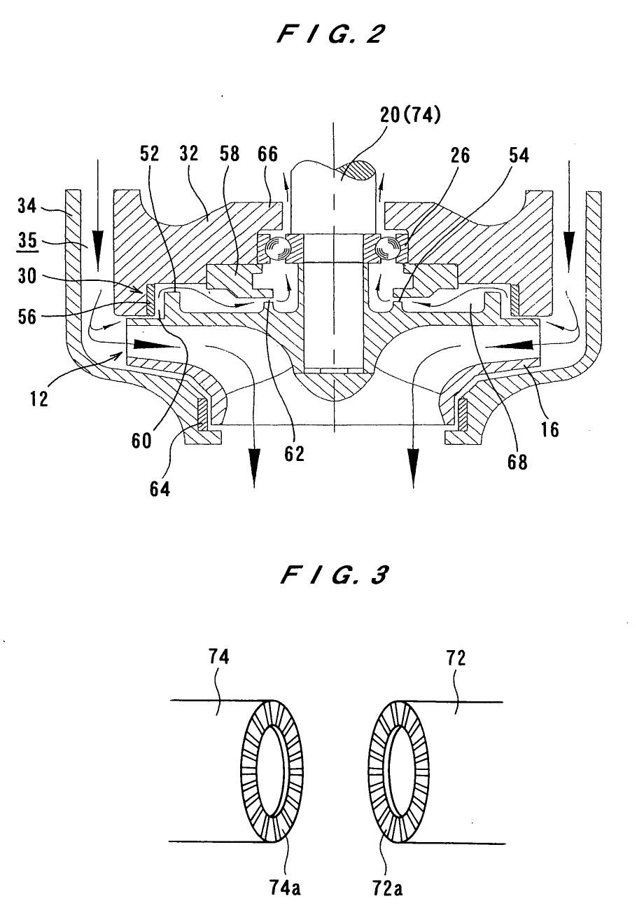

FIG. 1 is a cross-sectional view showing a so-called vertical submerged turbine generator according to an embodiment of the present invention, and FIG. 2 is an enlarged view showing an essential part shown in FIG. 1. As shown in FIG. 1, the submerged turbine generator comprises a turbine 12 and a generator 14. The turbine 12 has a runner 16, and the generator 14 has a rotor 18. The runner 16 and the rotor 18 are fixed to a shaft 20. In this embodiment, a working fluid, which is used for rotating the turbine 12 to generate electric power and used for cooling the generator 14, is a non-electrical-conductive fluid containing a liquefied low-temperature gas. Examples of such a working fluid include liquefied natural gas, liquefied methane gas, liquid ethylene gas, liquid petroleum gas, liquid nitrogen, and similar liquid hydrocarbon. A working fluid source 22 stores a desired working fluid, which is obtained, for example, from a well, and supplies the working fluid to the turbine 12 at fluctuating pressure or at constant pressure and velocity.

The runner 16 of the turbine 12 is attached to the shaft 20 so as to integrally rotate with the shaft 20 as the working fluid flows therethrough, and rotates the shaft 20 at a speed that changes depending on the pressure and the velocity of the working fluid. The rotor 18 of the generator 14 is also attached to the shaft 20 so as to integrally rotate with the shaft 20. The shaft 20 is rotatably supported by an upper bearing 24 and a lower bearing 26, which are arranged vertically. A ball bearing, for example, is used as the upper bearing 24 and the lower bearing 26. An exducer 28 is provided on the shaft 20 at a position below the runner 16, and receives the working fluid which has passed through the runner 16. The exducer 28 is attached to the shaft 20 so as to rotate integrally with the shaft 20. The turbine 12 has a thrust balancing mechanism 30, which will be described in detail later. It is preferable that the shaft 20 is vertically disposed, as shown in this embodiment, so that all forces exerted on the shaft 20 can be balanced.

The generator 14 is housed in a housing 32 which encloses and isolates the generator 14. All portions of the shaft 20, other than portions extending through the runner 16 and the exducer 28, are located in the housing 32. The housing 32 completely encloses all elements of a shaft assembly located above the runner 16. The housing 32 is accommodated in a casing 34 with a certain distance therebetween, so that a main passage 35 of the working fluid is formed between the housing 32 and the casing 34. An inlet 36, through which the working fluid is taken in, is formed in an upper portion of the casing 34 at a position near an inlet flange. The working fluid source 22 is connected to the casing 34 through a main line 33 attached to the inlet flange.

An outlet 38 of the working fluid is formed in a lower portion of the casing 34. The outlet 38 of the working fluid is located near a lower end portion of the shaft 20 and an outlet flange. After passing through the exducer 28, the working fluid is discharged to the exterior of the turbine generator through the outlet 38. The working fluid, which is supplied from the working fluid source 22 through the main line 33, flows into the casing 34 through the inlet 36, and flows along the main passage 35 formed around the housing 32. A nozzle 40 is provided in the main passage 35 at its turbine-side end, so that the working fluid is discharged through the nozzle 40 to impinge on the runner 16 extending radially. The nozzle 40 of this embodiment is an axial nozzle. After passing through the runner 16, the working fluid flows into the exducer 28, and is then discharged to the exterior of the turbine generator through the outlet 38.

An electric-cable path 42, communicating with the inner space of the housing 32, is provided on the housing 32. The electric-cable path 42 extends through the wall of the casing 34 and extends outwardly from the casing 34. An upper end of the electric-cable path 42 is sealed by a sealing member 44. A lead cable 46 is connected to the generator 14, extends through the electric-cable path 42 to reach its upper end, and further extends through the sealing member 44 to the exterior of the turbine generator. The lead cable 46 has an exposed output joint, i.e., an exposed output contact, through which the generator 14 is electrically connected to a certain utility unit selected in advance. The lead cable 46 has a wire connected to a variable frequency excitation power source 70 which supplies electric power to a stator 48 of the generator 14, which will be described later. One end of a discharge conduit 50 is connected to the electric-cable path 42, and the other end of the discharge conduit 50 is connected to the casing 34 at a position below the exducer 28. The discharge conduit 50 receives a part of the working fluid that has passed through the generator 14.

The thrust balancing mechanism 30 for canceling a thrust load applied to the shaft 20 is provided on the turbine 12. The turbine 12 has the runner 16 for receiving a flow of the working fluid discharged from the nozzle 40. A shape of paths formed in the runner 16 is such that the flow of the working fluid makes about a 90 degree turn. The flow of the working fluid received by the runner 16 has a relatively high velocity because a fluid pressure is converted into a high-velocity flow. The runner 16 is rotated by the working fluid applied thereto, and the working fluid flows out from the rotating runner 16 substantially along the axial direction of the shaft 20 to form a rotating compound flow in which a radial flow and an axial flow are mixed.

After being discharged from the runner 16, the rotating flow of the working fluid enters the exducer 28 which rotates together with the shaft 20. The exducer 28 comprises two spiral vanes arranged at angular intervals of 180 degrees. With this structure, the rotating flow of the working fluid given by the runner 16 is converted into a linear flow by interaction with the exducer (spiral vanes) 28. The working fluid is then discharged as an axial flow from the casing 34.

A throttle ring 52 and a projecting portion 54 are formed on the back surface of the runner 16. The throttle ring 52 projects in the axial direction toward the housing 32. The projecting portion 54 has a ring shape. The throttle ring 52 functions together with a first wearing ring 56 provided on the housing 32, and the projecting portion 54 functions together with a thrust plate 58 fixed to the lower end portion of the housing 32. A fixed orifice 60 is formed between the throttle ring 52 and the first wearing ring 56, and a variable orifice 62 is formed between the projecting portion 54 and the thrust plate 58. The thrust balancing mechanism 30 comprises the fixed orifice 60 and the variable orifice 62, and operates when the flow of the working fluid is applied to the runner 16.

FIG. 2 shows the thrust balancing mechanism 30 in a state immediate after the flow of the working fluid is applied to the turbine 12. The runner 16 has the throttle ring 52 adjacent to the first wearing ring 56 fixed to a downwardly projecting portion of the housing 32. A second wearing ring 64 is fixed to the casing 34 at a position near an outlet of the runner 16. The diameter of the first wearing ring 56 is larger than that of the second wearing ring 64, so that the diameter difference between the first wearing ring 56 and the second wearing ring 64 generates an upward thrust force. Arrangements and structures of the runner 16, the first wearing ring 56, and the throttle ring 52 are designed such that a part of the working fluid discharged from the nozzle 40 flows into a gap between the first wearing ring 56 and the throttle ring 52. The thrust balancing mechanism 30 operates using a part of the working fluid.

Next, operations of the thrust balancing mechanism 30 will be described in detail with reference to FIG. 2. The lower bearing 26 has an inner race fixed to the shaft 20. An outer race of the lower bearing 26 is loosely attached to the housing 32 so that the shaft 20 can move along the axial direction by a distance selected for balancing the generated thrust load. A stopper 66 is provided on the housing 32. The stopper 66 is normally spaced from the lower bearing 26. The thrust plate 58 is fixed to the lower end portion of the housing 32.

The fixed orifice 60 is formed between the first wearing ring 56 and the throttle ring 52. The working fluid flows through the fixed orifice 60, and then flows into the variable orifice 62. The variable orifice 62 is formed between the projecting portion 54 and the thrust plate 58. A clearance between the lower bearing 26 and the stopper 66 is set substantially equal to a gap of the variable orifice 62 in a starting state.

In operation, after passing through the nozzle 40 and before flowing into the runner 16, the energy of the working fluid decreases by an amount required for converting a high fluid pressure into a high fluid velocity in the nozzle 40. A pressure distribution due to leakage of the working fluid flowing along the back surface of the runner 16 serves as a main energy source for operating the thrust balancing mechanism 30. Under such conditions, the upward thrust force is generated by the diameter difference between the wearing rings 56 and 64, and by pressures developed at the front and back surfaces of the runner 16. Such upward thrust force moves the shaft 20 upwardly along the axial direction of the shaft 20. FIG. 2 shows such a state of the thrust balancing mechanism 30. The working fluid flows through the fixed orifice 60 and the variable orifice 62 into the housing 32 through the lower bearing 26, and further flows through the generator 14 into the electric-cable path 42.

This flow of the working fluid lubricates and cools the lower bearing 26, and also cools the generator 14. After flowing into the electric-cable path 42, the working fluid flows through the discharge conduit 50 and then returns to the low-pressure outlet side of the turbine 12. The runner 16 is continuously lifted in the axial direction by the thrust force generated during operation, and therefore a gap, i.e., a size, of the variable orifice 62 decreases continuously until the projecting portion 54 comes in contact with the thrust plate 58. In this manner, the thrust plate 58 restricts the upward movement of the shaft 20. The initial gap or width of the variable orifice 62 is considerably larger than the gap of the fixed orifice 60 at the time of starting the turbine 12. This is because the gap of the fixed orifice 60 is determined by a clearance between the first wearing ring 56 and the throttle ring 52. The upper bearing 24 is cooled by the high-pressure working fluid supplied through a fluid passage 69 formed in the top portion of the housing 32.

When the shaft 20 completes the upward movement, the working fluid passing through the variable orifice 62 is squeezed. Squeezing of the working fluid produces the fluid pressure in a variable pressure chamber 68 formed between the closed variable orifice 62 and the first wearing ring 56. The pressure developed in the variable pressure chamber 68 serves to cancel the thrust force generated due to the diameter difference between the wearing rings 56 and 64, and therefore the shaft 20 is moved downwardly. The downward movement of the shaft 20 creates the gap in the variable orifice 62 again. As a result, the pressure in the variable pressure chamber 68 is lowered, whereby the shaft 20 is moved upwardly in the axial direction. Such up-and-down movement of the shaft 20 continues during the operation of the turbine 12 to thereby balance the thrust force applied to the turbine 12. Therefore, the thrust balance mechanism 30 serves as a thrust bearing. The lower bearing 26 also serves as a thrust bearing at the time of starting and stopping the turbine generator.

The working fluid source 22 supplies a high-pressure working fluid to allow the runner 16 to produce a torque high enough to rotate the shaft 20 at a desired speed. For any type of working fluid, the fluid pressure can be changed by changing a head, for example, and a generated centrifugal force can be adjusted by reducing a speed given to the shaft 20.

It is preferable that the generator 14 is an induction generator. An induction motor is driven at a higher speed than a synchronous speed under the condition that the induction motor is connected to an excitation power source. Therefore, a mechanical force applied to a shaft of the induction generator is converted into electric power, which is the reverse of a motor. When the induction motor is driven at a higher speed than the synchronous speed, a slip becomes negative. The higher the torque exerted on the shaft (the turbine 12, in this case) of the generator (induction generator) 14 becomes, the greater the electric power generated by the generator 14 becomes.

As shown in FIG. 1, the generator (induction generator) 14 has the rotor 18 attached to the shaft 20 that is integrally rotatable with the turbine 12. The generator 14 also has the stator 48 surrounding the rotor 18 with a space therebetween. The stator 48 is connected to the variable frequency excitation power source 70, which can change a frequency of a rotating field produced by the stator 48. For this purpose, the variable frequency excitation power source 70 is a unit having a controller for controlling an output with a variable speed and a constant frequency, which may be commercially available.

The variable frequency excitation power source 70 allows its output to have a predetermined constant frequency. Thus, the shaft 20, i.e., the turbine 12 and the generator 14, can be efficiently driven at a frequency appropriately selected in advance from among a susceptible frequency range in accordance with given fluid conditions.

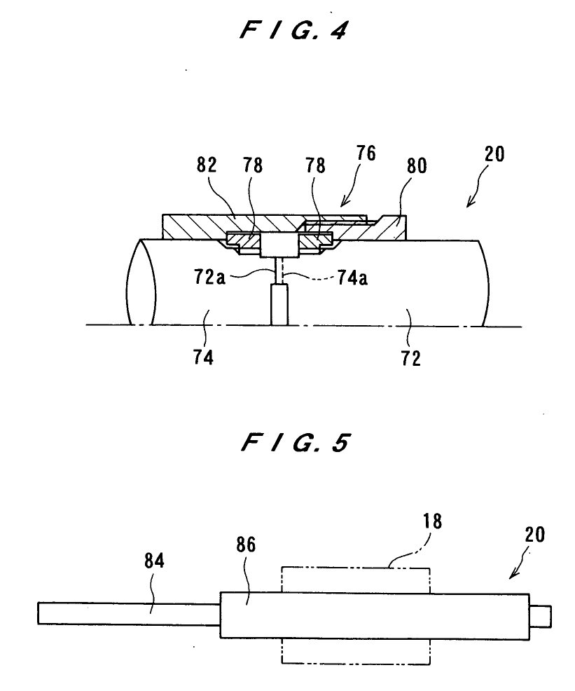

The shaft 20 of this embodiment comprises a generator-side shaft 72 to which the rotor 18 is fixed, a turbine-side shaft 74 to which the runner 16 is fixed, and a shaft coupling 76 through which the generator-side shaft 72 and the turbine-side shaft 74 are coupled in series. As shown in FIGS. 3 and 4, plane teeth 72a are formed on an end surface, facing the turbine-side shaft 74, of the generator-side shaft 72, and plane teeth 74a are formed on an end surface, facing the generator-side shaft 72, of the turbine-side shaft 74. The generator-side shaft 72 and the turbine-side shaft 74 are coupled in series in such a state that the plane teeth 72a and 74a engage each other. Accordingly, the rotation of the turbine-side shaft 74 can be securely transmitted to the generator-side shaft 72.

The shaft coupling 76 comprises, as shown in FIG. 4, a pair of coupling holders 78 screwed respectively onto the end portions of the generator-side shaft 72 and the turbine-side shaft 74, and further comprises a male coupling part 80 and a female coupling part 82. The pair of coupling holders 78, which have screwed respectively onto the end portions of the generator-side shaft 72 and the turbine-side shaft 74, are tightly interposed between the male coupling part 80 and the female coupling part 82, and the female coupling part 82 is screwed onto the male coupling part 80, whereby the generator-side shaft 72 and the turbine-side shaft 74 are coupled to each other in series.

The rotation of the runner 16 of the turbine 12 is thus securely transmitted to the rotor 18 of the generator 14 through the shaft 20. The shaft 20 has a portion to which the runner 16 is fixed. This portion is required to have as small a diameter as possible within permissible limits of strength in order to increase an area of the outlet of the runner 16. Further, in order to improve performance of the generator 14, a portion of the shaft 20 to which the rotor 18 is fixed should preferably be made of magnetic material.

Specifically, since the rotor 18 of the generator 14 is fixed to the generator-side shaft 72, it is preferable that the generator-side shaft 72 has magnetic properties. Thus, magnetic material is preferably used to form the generator-side shaft 72. Additionally, since the runner 16 of the turbine 12 is fixed to the turbine-side shaft 74, it is preferable that the turbine-side shaft 74 has a high mechanical strength. Thus, a high-strength material is preferably used to form the turbine-side shaft 74. With this structure, the turbine generator having excellent strength and excellent magnetic properties can be provided. Further, because the generator-side shaft 72 and the turbine-side shaft 74 are coupled to form the shaft 20, a length of the generator-side shaft 72 and the turbine-side shaft 74 can be short compared with a shaft formed from a single member. Accordingly, workability can be improved.

Although the plane-teeth coupling represented by a curvic coupling is used as the shaft coupling 76 in this embodiment, other types of shaft couplings using splines, bolts, or the like can be used. The plane teeth are not necessarily provided directly on the end surfaces of the generator-side shaft 72 and the turbine-side shaft 74. Specifically, the plane teeth may be provided on a certain member, and this member may be attached to the end surface of the generator-side shaft 72 or the turbine-side shaft 74. In this case also, workability can be improved.

FIG. 5 shows a modified example of the shaft 20. In this example, the shaft 20 comprises a solid shaft 84 extending from one end to the other end of the shaft 20, and a sleeve shaft 86 surrounding a part of the solid shaft 84. The runner 16 (see FIG. 1) of the turbine 12 is fixed to an end portion of the solid shaft 84, and the rotor 18 of the generator 14 is fixed to the sleeve shaft 86.

Generally, a diameter of a portion of the shaft 20 to which the rotor 18 is fixed is determined by a punch die used for a rotor core. This diameter is about 1.5 to 3 times the diameter of a portion of a shaft to which a runner is fixed. Therefore, the double structure comprising the solid shaft 84 and the sleeve shaft 86 contributes to easy production of the shaft 20 having a diameter suitable for the rotor 18 and a diameter suitable for the runner 16. Further, the combination of the solid shaft 84 made of a high-strength material and the sleeve shaft 86 made of a magnetic material can optimize qualities of the shaft 20 which requires high strength and magnetic properties, as with the above example. In this case also, the turbine generator having excellent strength and excellent magnetic properties can be provided. Furthermore, because a maximum diameter of the solid shaft 84 can be very small, a diameter of a raw material can be small, and therefore a cutting amount and a load on the environment can be reduced.

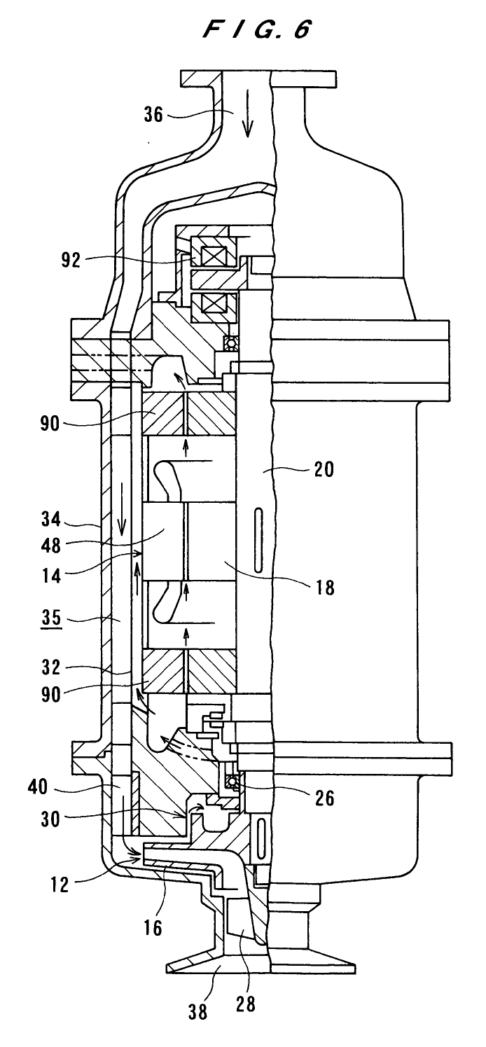

FIG. 6 shows a submerged turbine generator according to another embodiment of the present invention. This embodiment is different from that shown in FIGS. 1 through 4 in the following points. The vertical main shaft 20 to which the runner 16 of the turbine 12 and the rotor 18 of the generator 14 are fixed is rotatably supported by a pair of radial magnetic bearings 90 and a thrust magnetic bearing 92. The radial magnetic bearings 90 and the thrust magnetic bearing 92 are located in the housing 32. The pair of radial magnetic bearings 90 are disposed so as to interpose the rotor 18 of the generator 14. The thrust magnetic bearing 92, serving as an upper bearing, is disposed at the upper end portion of the shaft 20, and supports the thrust load applied to the shaft 20 at rest and start-up. The thrust balancing mechanism 30 is provided to balance the thrust load applied to the shaft 20 during normal operation, as with the above-mentioned embodiment.

The thrust balancing mechanism 30 serves to cancel the thrust load only during normal operation. Consequently, the thrust load is applied to the thrust bearing at start-up for a short time. Under such situations, if a single-row deep-groove ball bearing is used to support the thrust load, the life of the turbine generator as a whole may be shortened because the single-row deep-groove ball bearing generally has a poor capability of supporting the thrust load. Generally, a magnetic bearing has a low ratio of a supporting capability to its volume. Accordingly, if the magnetic bearing is used to support the thrust load during normal operation, the bearing itself becomes very large in size.

In this embodiment, the thrust magnetic bearing (the upper bearing) 92 serves to support the thrust load at rest and start-up, and the thrust balancing mechanism 30 serves to support the thrust load during normal operation, so that the thrust magnetic bearing 92 can cancel the thrust load at rest and start-up, and the thrust balancing mechanism 30 can cancel the thrust load during normal operation.

The thrust magnetic bearing 92 covers a range from a resting state to a low rotational speed at which the thrust balancing mechanism 30 does not properly function. In this range, a dynamic thrust load caused mainly by the turbine differential pressure is small, and a static thrust load is smaller than the weight of the rotor 18. Therefore, the thrust magnetic bearing 92 can be smaller in size than a bearing for normal operation. A target position of the rotor 18 controlled by the thrust magnetic bearing 92 is set equal to an axial position of the rotor 18 determined by the operation of the thrust balancing mechanism 30, whereby an unwanted moving force is prevented from being produced in the thrust magnetic bearing 92 during normal operation.

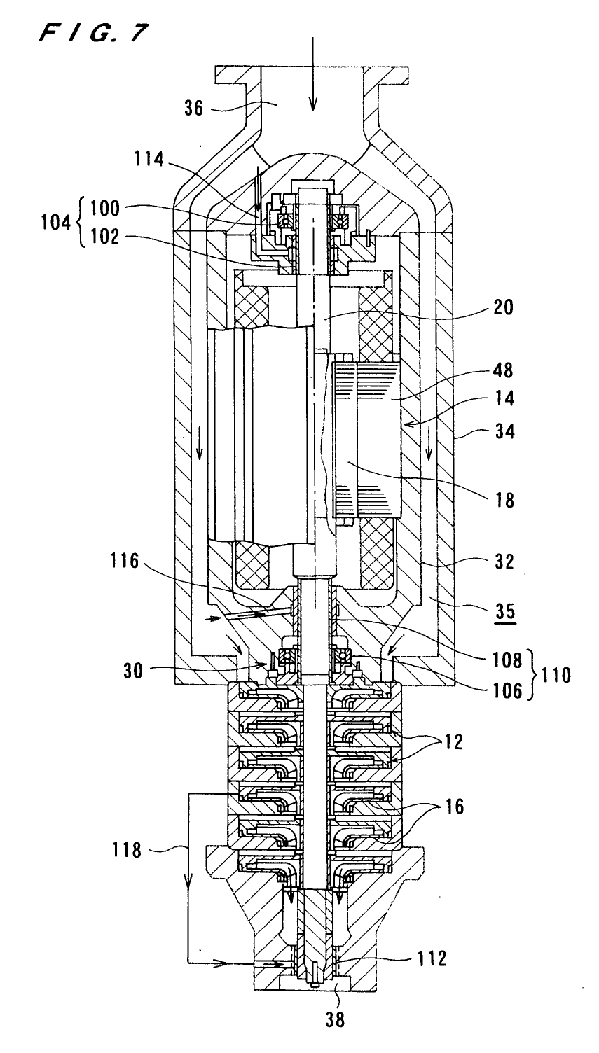

FIGS. 7 through 9 are a submerged turbine generator according to still another embodiment of the present invention. This embodiment is different from that shown in FIGS. 1 through 4 in the following points. A plurality of turbine stages 12 are straightly arranged so as to face the same direction to form a multistage turbine. Each of the turbine stages 12 has a runner 16 fixed to the shaft 20. The thrust balancing mechanism 30, which serves to balance the thrust load applied to the shaft 20, is disposed between the first-stage turbine 12 and the housing 32 in which the generator 14 is housed. In this embodiment, the shaft 20 is rotatably supported by an upper bearing 104 and a lower bearing 110. The upper bearing 104 comprises a contact bearing section (ball bearing) 100 and a non-contact bearing section (hydrostatic bearing) 102, and the lower bearing 110 comprises a contact bearing section (ball bearing) 106 and a non-contact bearing section (hydrostatic bearing) 108. Additionally, the lower end portion of the shaft 20 is rotatably supported by a lower end bearing (hydrostatic bearing) 112. The lower end bearing 112 may be eliminated.

A high-pressure working fluid is supplied to the non-contact bearing section (hydrostatic bearing) 102 of the upper bearing 104 through a first fluid passage 114 communicating with the main passage 35. The high-pressure working fluid is also supplied to the non-contact bearing section (hydrostatic bearing) 108 of the lower bearing 110 through a second fluid passage 116 communicating with the main passage 35. Further, the working fluid is supplied to the lower end bearing (hydrostatic bearing) 112 through a third fluid passage 118 extending from the middle-stage turbine 12.

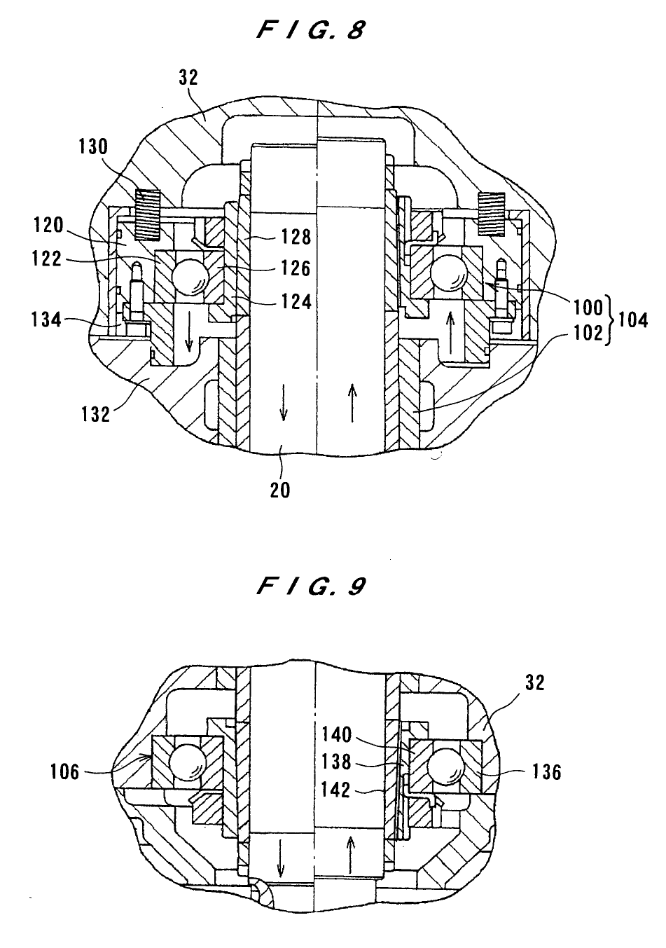

The contact bearing section (ball bearing) 100 of the upper bearing 104 and the contact bearing section (ball bearing) 106 of the lower bearing 110 support the thrust load and the radial load, which are applied to the shaft 20, only at rest and start-up. As shown in FIG. 8, the contact bearing section (ball bearing) 100 comprises an outer race 122 fixed to a vertically movable bearing housing 120, and an inner race 126 to which a bearing sleeve 124 is attached. The vertically movable bearing housing 120 is housed in the housing 32. The bearing sleeve 124 has a tapered inner circumferential surface whose diameter gradually decreases toward its upper end. A shaft sleeve 128 is fixed to the shaft 20, and has a tapered outer circumferential surface engaging the tapered inner circumferential surface of the bearing sleeve 124. A compression coil spring 130 is disposed between the bearing housing 120 and the housing 32. The compression coil spring 130 serves to bias the contact bearing section 100 downwardly via the bearing housing 120. The bearing housing 120 and a bearing retainer 132 form a variable pressure chamber 134 communicating with a high-pressure fluid region during normal operation.

As shown in FIG. 9, the contact bearing section (ball bearing) 106 of the lower bearing 110 comprises an outer race 136 fixed to the housing 32, and an inner race 140 to which a bearing sleeve 138 is attached. The bearing sleeve 138 has a tapered inner circumferential surface whose diameter gradually decreases toward its lower end. A shaft sleeve 142 is fixed to the shaft 20, and has a tapered outer circumferential surface engaging the tapered inner circumferential surface of the bearing sleeve 138.

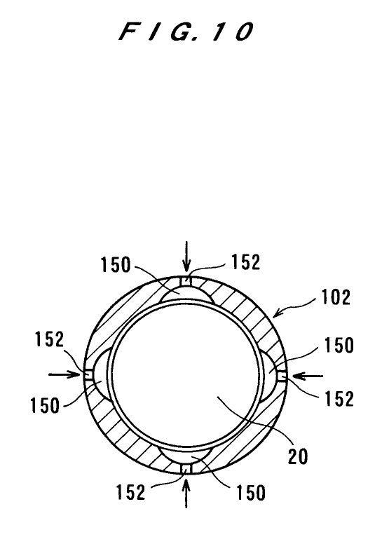

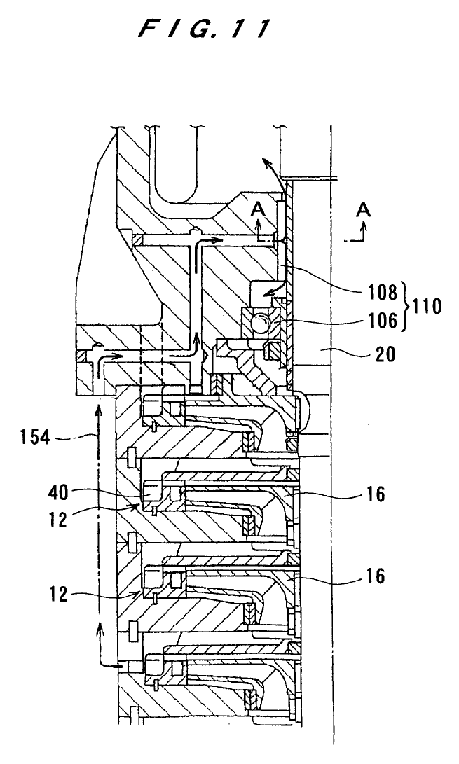

As shown in FIG. 10, the non-contact bearing section (hydrostatic bearing) 102 of the upper bearing 104 has a plurality of pockets 150 formed on an inner surface thereof, and has a plurality of orifices 152 for supplying the high-pressure working fluid to the pockets 150. With this structure, the high-pressure working fluid flows through the first fluid passage 114 and is introduced into the pockets 150 through the orifices 152, so that the shaft 20 is supported by the static pressure of the fluid (liquid) in the pockets 150. The non-contact bearing section (hydrostatic bearing) 108 and the lower end bearing (hydrostatic bearing) 112 have substantially the same structure as the non-contact bearing section (hydrostatic bearing) 102.

In this embodiment, when the submerged turbine generator is at rest, the shaft 20 is located at a lowered position due to gravity, as shown in a left half of FIG. 9. In this state, the tapered circumferential surfaces of the bearing sleeve 138 and the shaft sleeve 142 engage each other, whereby the shaft 20 is supported by the contact bearing section 106 of the lower bearing 110 with no gap and no bias. As shown in a left half of FIG. 8, when the shaft 20 moves downwardly, the contact bearing section 100 of the upper bearing 104 is moved together with the bearing housing 120 by the biasing force of the compression coil spring 130 so as to follow the downward movement of the shaft 20. As a result, the tapered circumferential surfaces of the bearing sleeve 124 and the shaft sleeve 128 engage each other to allow the contact bearing section 100 to support the shaft 20 with no gap and no bias.

After the submerged turbine generator starts operation and when the turbine differential pressure reaches a predetermined value, the thrust balancing mechanism 30 starts operation to levitate the shaft 20 upwardly. At this time, as shown in a right half of FIG. 9, the shaft sleeve 142 is freed from the engagement with the tapered inner circumferential surface of the bearing sleeve 138, and is levitated in the axial direction of the shaft 20. Accordingly, the shaft sleeve 142 and the bearing sleeve 138 are out of contact with each other, and a gap is formed therebetween. Therefore, no load is applied to the contact bearing section 106 of the lower bearing 110, and the contact bearing section 106 does not rotate.

As shown in a right half of FIG. 8, the levitation of the shaft 20 elevates the shaft sleeve 128 and the bearing sleeve 124 in the axial direction of the shaft 20, and also elevates the contact bearing section 100 of the upper bearing 104. At this time, under the fluid pressure introduced into the variable pressure chamber 134, the bearing housing 120 is elevated against the biasing force of the compression coil spring 130 by a distance larger than the levitation distance of the shaft 20. Accordingly, the engagement between the tapered circumferential surfaces of the bearing sleeve 124 and the shaft sleeve 128 is broken, and a radial gap is formed therebetween. Therefore, no load is applied to the contact bearing section 100 of the upper bearing 104, and the contact bearing section 100 does not rotate.

In the submerged turbine generator, the working fluid is used to lubricate the bearings. Generally, the working fluid has a low lubricating capability, and therefore the bearings should be replaced at regular time intervals. According to this embodiment, the contact bearing sections 100 and 106 are used to support the shaft 20 only at rest and start-up. Therefore, the contact bearing sections 100 and 106 can have a longer life than that of the submerged turbine generator as a whole. During normal operation, the shaft 20 is supported by the non-contact bearing sections 102 and 108, which are hydrostatic bearings utilizing the turbine differential pressure or hybrid bearings utilizing both static pressure and dynamic pressure. Therefore, it is possible to prevent contact problems from occurring due to lack of differential pressure at low speed operation such as at start-up.

As shown in FIG. 11, a fluid passage 154 extending from a certain-stage turbine 12 to the non-contact bearing section (hydrostatic bearing) 108 may be provided so that the working fluid having a reduced pressure can be supplied to the non-contact bearing section 108 through the fluid passage 154.

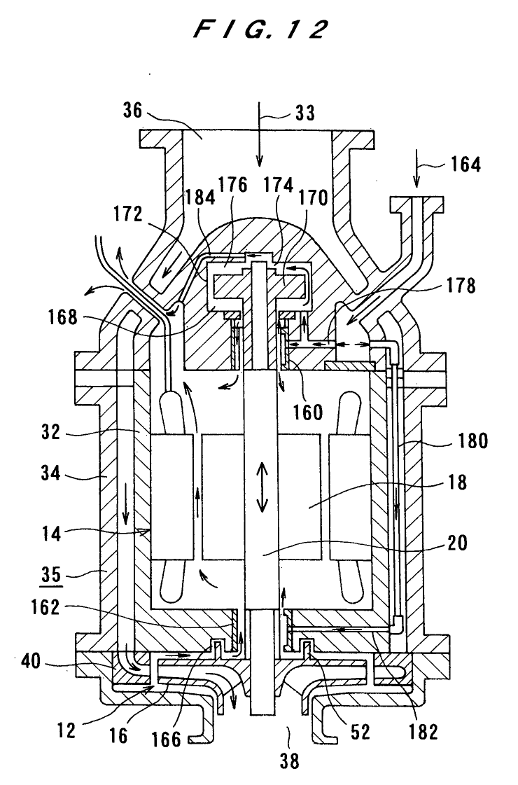

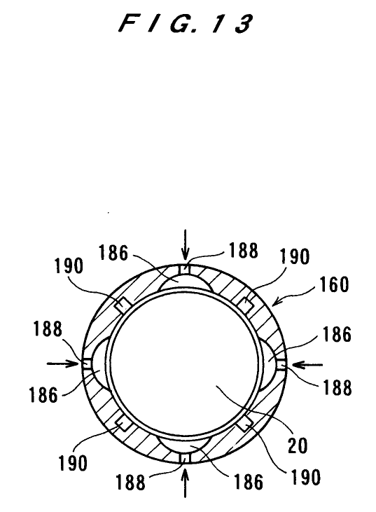

FIGS. 12 and 13 show a submerged turbine generator according to still another embodiment of the present invention. This embodiment is different from that shown in FIGS. 1 through 4 in the following points. The shaft 20 is rotatably supported by an upper bearing 160 and a lower bearing 162, each of which is a hydrostatic bearing. A secondary line 164 for supplying the high-pressure working fluid into the housing 32 is provided, in addition to the main line 33 through which the high-pressure working fluid is supplied from the working fluid source 22 (see FIG. 1) to the main passage 35 formed between the housing 32 and the casing 34.

A fixed orifice 166 is provided between the housing 32 and the throttle ring 52 which is provided on the back surface of the runner 16. A balance sleeve 170 is fixed to the upper portion of the shaft 20, and is housed in a housing portion 168 formed in the housing 32. The balance sleeve 170 is vertically movable in the housing portion 168. A fixed orifice 172 and a variable orifice 174 are provided between the balance sleeve 170 and the housing 32. When the variable orifice 174 is closed, a variable pressure chamber 176 is formed between the balance sleeve 170 and the housing 32. A thrust balancing mechanism is thus constructed.

A first fluid passage 178 is provided inside the housing 32. The first fluid passage 178 serves to supply the high-pressure working fluid, which has been supplied into the housing 32 through the secondary line 164, to the upper bearing (hydrostatic bearing) 160 and the housing portion 168. A connection pipe 180 is provided to deliver the high-pressure working fluid, which has been supplied into the housing 32 through the secondary line 164, to the lower bearing (hydrostatic bearing) 162 side. A second fluid passage 182 communicating with the connection pipe 180 is provided in the housing 32. The second fluid passage 182 serves to introduce the high-pressure fluid, which is being delivered through the connection pipe 180, to the lower bearing (hydrostatic bearing) 162. A return line 184 for connecting the housing portion 168 and the inside of the housing 32 to each other is provided in the housing 32.

As shown in FIG. 13, the upper bearing (hydrostatic bearing) 160 has a plurality of pockets 186 formed on an inner surface thereof, and has a plurality of orifices 188 through which the high-pressure working fluid is supplied to the pockets 186. The high-pressure working fluid flows through the first fluid passage 178, and is introduced into the pockets 186 through the orifices 188, so that the shaft 20 is supported by the static pressure of the working fluid in the pockets 186. Relief passages 190, which extend through the upper bearing (hydrostatic bearing) 160 in the axial direction of the shaft 20, are provided so that the low-pressure working fluid can be released through the relief passages 190. The lower bearing (hydrostatic bearing) 162 has the same structure as the upper bearing 160.

In this embodiment, before starting the turbine 12, the high-pressure working fluid is introduced into the housing 32 through the secondary line 164, and is supplied to the upper bearing 160 and the lower bearing 162, both of hydrostatic bearings. Then, the high-pressure working fluid is supplied to the main passage 35 through the main line 33 to thereby start rotating the turbine 12.

As described above, the non-contact bearing, such as the hydrostatic bearing, or the hybrid bearing utilizing both static pressure and dynamic pressure is used as the upper bearing 160 and the lower bearing 162. In this case, before starting the turbine 12, the high-pressure working fluid is supplied to the upper bearing 160 and the lower bearing 162 through the secondary line 164, thus allowing the upper bearing 160 and the lower bearing 162 to have a supporting capability. Accordingly, the upper bearing 160 and the lower bearing 162 can be kept out of contact with the shaft 20 at all times, i.e., during resting state, operating state, and stop state. Therefore, a maintenance-free turbine generator can be provided. The upper bearing 160 and the lower bearing 162 may be a dynamic-pressure bearing, such as a foil bearing, or a ball bearing. In this case also, before starting the turbine 12, the high-pressure working fluid is supplied to the upper bearing 160 and the lower bearing 162 through the secondary line 164, resulting in improved lubricating and cooling effects and a longer life.

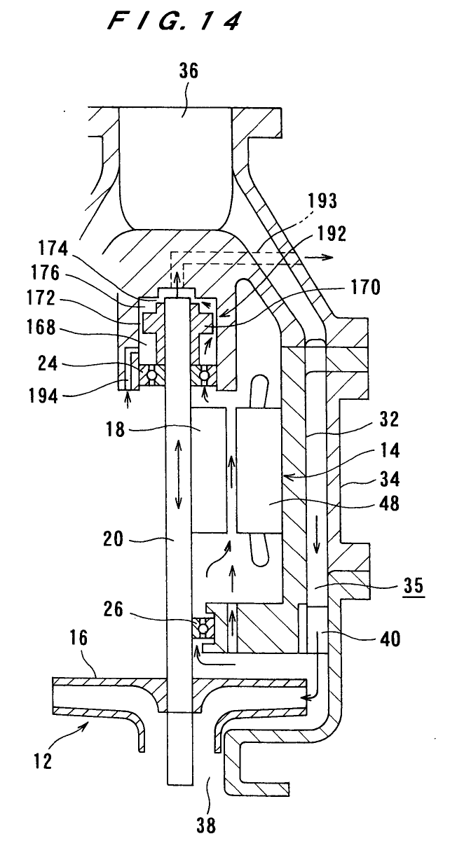

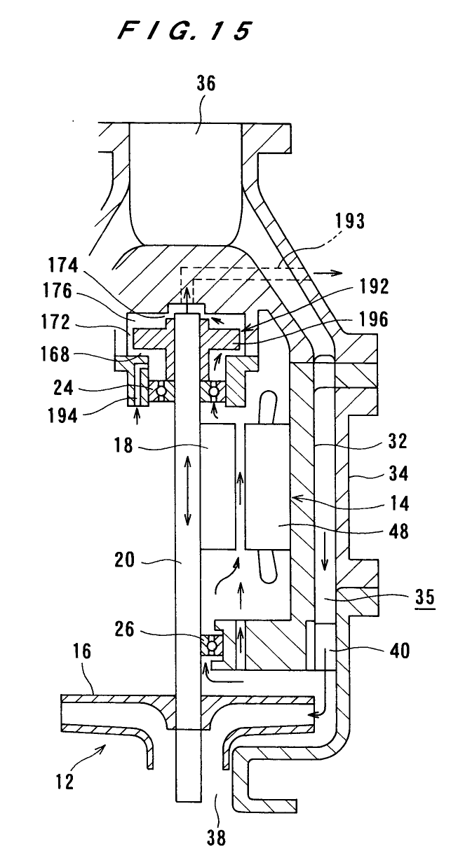

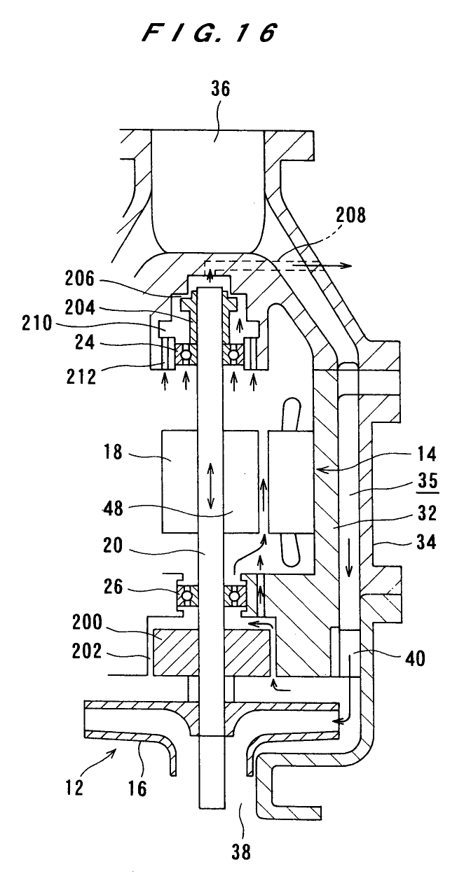

FIG. 14 shows a submerged turbine generator according to still another embodiment of the present invention. This embodiment is different from that shown in FIGS. 1 through 4 in the following points. The fixed orifice and the variable orifice are not provided between the runner 16 and the housing 32, but are provided above the upper bearing (e.g., ball bearing) 24 to constitute a thrust balancing mechanism.

Specifically, as with the above embodiment shown in FIG. 12, the housing portion 168 is formed in the housing 32, and the balance sleeve 170 is fixed to the upper portion of the shaft 20. The balance sleeve 170 is housed in the housing portion 168, and is vertically movable in the housing portion 168. The fixed orifice 172 and the variable orifice 174 are provided between the balance sleeve 170 and the housing 32. When the variable orifice 174 is closed, the variable pressure chamber 176 is formed between the balance sleeve 170 and the housing 32. A thrust balancing mechanism 192 is thus constructed. After passing through the variable orifice 174, the working fluid is discharged to the exterior of the turbine generator through a relief line 193.

In this embodiment, a bypass line 194 is provided so as to connect the inside of the housing 32 to the housing portion 168 so that the working fluid in the housing 32 is introduced to the upstream side of the fixed orifice 172, which is located in the housing portion 168. This bypass line 194 may be eliminated.

The pressure of the working fluid is reduced after the working fluid passes through the fixed orifice and the variable orifice of the thrust balancing mechanism. If the working fluid having a reduced pressure is used to cool the bearing, such working fluid may be evaporated during cooling of the bearing. Evaporation of the working fluid flowing through the bearing may result in damage to the bearing. In this embodiment, the fixed orifice 172 and the variable orifice 174, both of which constitute the thrust balancing mechanism 192, are disposed at an one end of the shaft 20 opposite to the other end to which the runner 16 is fixed, i.e., disposed above the upper bearing 24 of the shaft 20. With this arrangement, before passing through the thrust balancing mechanism 192, the working fluid is supplied to the upper bearing 24 and the lower bearing 26 disposed below the upper bearing 24. Therefore, the high-pressure working fluid, which is not likely to be evaporated, can be used to cool the upper bearing 24 and the lower bearing 26, thus preventing damage to the upper and lower bearings 24 and 26 due to cooling failure.

Only one of the fixed orifice 172 and the variable orifice 174 of the thrust balancing mechanism may be disposed at the opposite-runner-side end portion of the shaft 20, i.e., above the upper bearing 24.

Further, as shown in FIG. 15, instead of the balance sleeve 170 shown in FIG. 14, a balance drum 196 having a large diameter may be used.

FIG. 16 shows a submerged turbine generator according to still another embodiment of the present invention. This embodiment is different from that shown in FIGS. 1 through 4 in the following points. A balance sleeve 200 is fixed to the shaft 20 at a position below the lower bearing (e.g., ball bearing) 26. A fixed orifice 202 is provided between the balance sleeve 200 and the housing 32. A thrust sleeve 204 is fixed to the shaft 20 at a position above the upper bearing (e.g., ball bearing) 24. A variable orifice 206 is provided between the thrust sleeve 204 and the housing 32. The thrust balancing mechanism is thus constructed. After passing through the variable orifice 206, the fluid is discharged to the exterior of the turbine generator through a relief line 208.

In this embodiment, a bypass line 212 is provided so as to connect the inside of the housing 32 to a housing portion 210 in which the thrust sleeve 204 is housed, so that the fluid in the housing 32 is introduced to the upstream side of the variable orifice 206 which is located in the housing portion 210. This bypass line 212 may be eliminated.

Generally, the thrust balancing mechanism serves to balance the thrust load by utilizing the thrust force generated due to the diameter difference between the two wearing rings and by utilizing the fluid pressure in the variable pressure chamber formed between the variable orifice and the fixed orifice. Accordingly, the runner disposed at the side of the thrust balancing mechanism requires two wearing rings. This means that a multistage turbine requires two types of runners: one having a single wearing ring, and the other having two wearing rings. This also means that two types of casting patterns should be prepared to manufacture the multistage turbine. According to this embodiment, by providing the fixed orifice 202 of the thrust balancing mechanism between the housing 32 and the balance sleeve 200 fixed to the shaft 20, only one type of runner is required in manufacturing the multistage turbine.

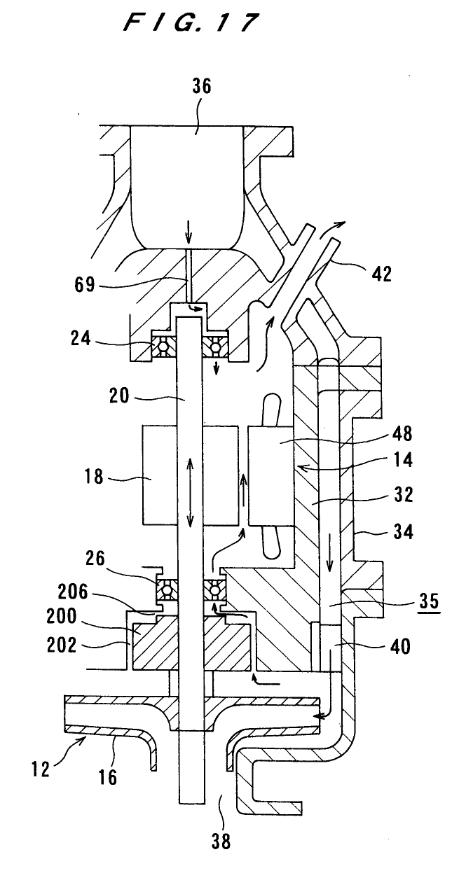

As shown in FIG. 17, both the fixed orifice 202 and the variable orifice 206 may be located below the lower bearing (e.g., ball bearing) 26 and formed between the housing 32 and the balance sleeve 200 fixed to the shaft 20. Such arrangements can also constitute the thrust balancing mechanism.

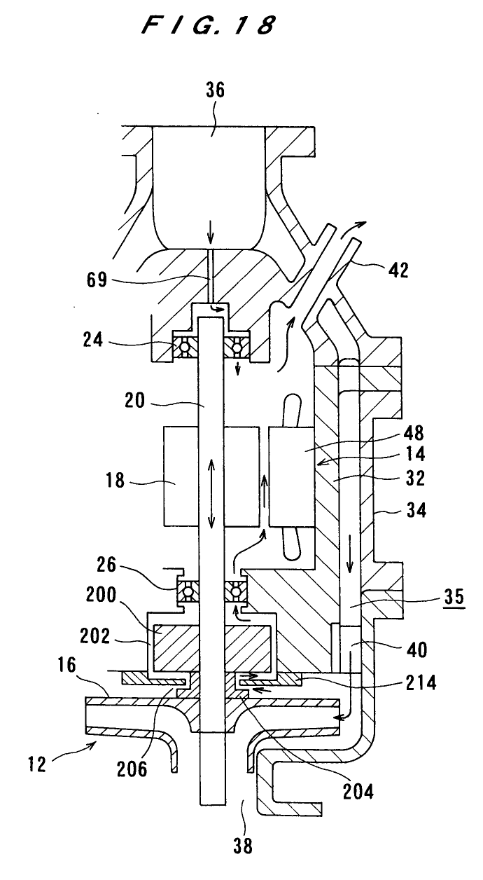

Further, as shown in FIG. 18, the fixed orifice 202 may be located below the lower bearing (e.g., ball bearing) 26 and formed between the housing 32 and the balance sleeve 200 fixed to the shaft 20. The variable orifice 206 may be located between the balance sleeve 200 and the runner 16 and formed between the thrust sleeve 204, which is fixed to the shaft 20, and a throttle ring 214, which is fixed to the housing 32. Such arrangements can also constitute the thrust balancing mechanism.

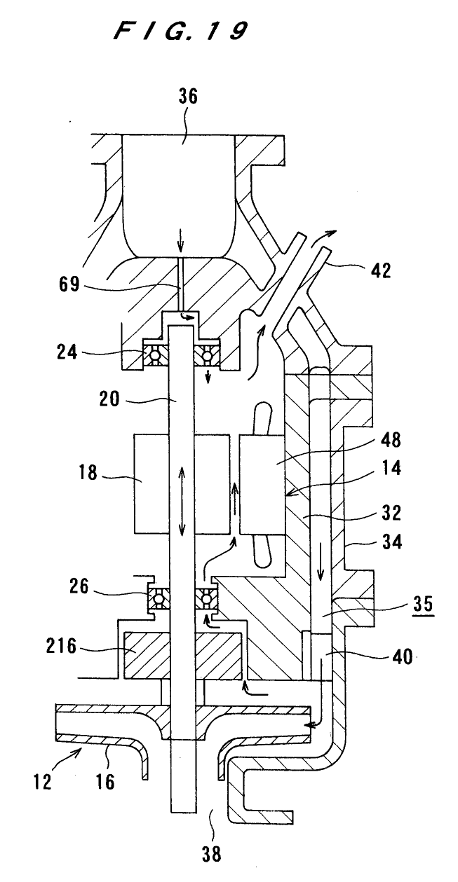

FIG. 19 shows a submerged turbine generator according to still another embodiment of the present invention. This embodiment is different from that shown in FIGS. 1 through 4 in the following points. A balance piston 216 is fixed to the shaft 20 at a position below the lower bearing (e.g., ball bearing) 26. The balance piston 216 has a predetermined diameter such that a force is generated to counteract the thrust load at specific operating point and reduce the thrust load during normal operation. In this embodiment, the balance piston 216 constitutes the thrust balancing mechanism for specific operation point.

The use of the balance piston 216, which has a relatively simple structure, can increase the life of the bearings by counteracting the thrust load during normal operation, and can simplify the structure of both the single-stage turbine generator and the multistage turbine generator having a plurality of turbine stages arranged in series facing the same direction.

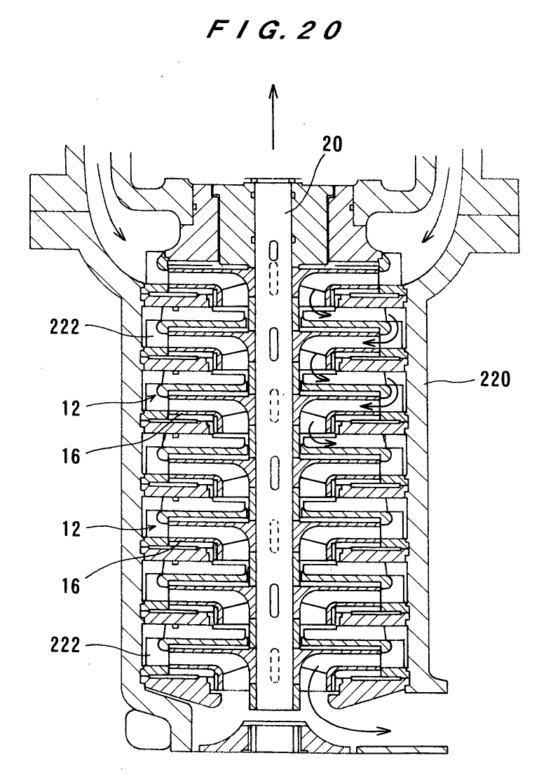

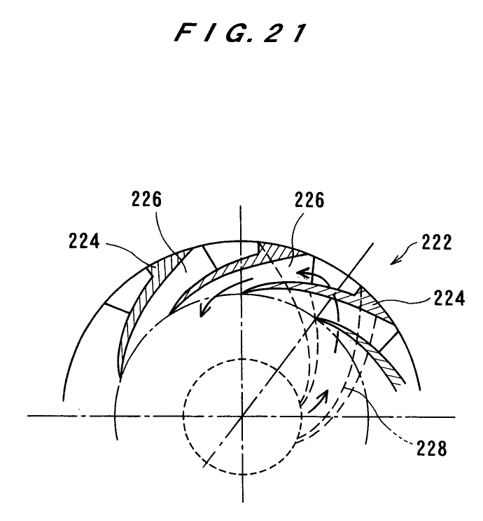

FIG. 20 shows turbine stages incorporated in a submerged turbine generator according to still another embodiment of the present invention. In this embodiment, a plurality of turbine stages 12 are straightly arranged so as to face the same direction to form a multistage turbine. The turbine stages 12 are housed in a turbine casing 220. Each of the turbine stages 12 has the runner 16 fixed to the shaft 20. The high-pressure working fluid is supplied to the turbine casing 220, and flows through the runners 16 from the first stage to the final stage successively, thereby rotating the shaft 20.

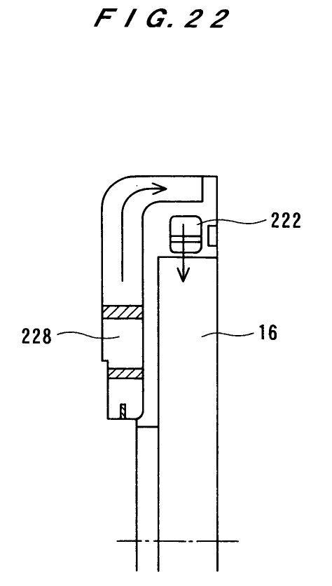

In this embodiment, a radial nozzle 222 is disposed near peripheral inlets of the runner 16 of each stage of the turbine stages 12. As shown in FIGS. 21 and 22, the radial nozzle 222 has a plurality of channels 226 extending spirally in a radial direction and defined by a plurality of nozzle vanes 224. With this structure, the working fluid discharged from the forward-stage turbine 12 is led to the channels 226 by return vanes 228. Then, the working fluid flows through the channels 226 and is ejected radially inwardly into the runner 16 of the next-stage turbine 12.

As previously described, an axial nozzle may be disposed upstream of the runner 16 so as to lead the working fluid to the runner 16. However, in this case, the inlets of the runner 16 and the outlets of the axial nozzle should be spaced from each other by a certain distance, and the working fluid flowing through a path between the runner 16 and the axial nozzle is forced to turn at a substantially right angle. Such arrangements and a change in the flowing direction impose a limit on the turbine performance.

According to this embodiment, since the radial nozzle 22 is disposed near the peripheral inlets of the runner 16, the working fluid in the radial nozzle 222 can form a straight meridional flow running radially. Further, a distance between the outlets of the radial nozzle 222 and the inlets of the runner 16 can be set short. Accordingly, the runner 16 can receive energy of the flow from the radial nozzle 222 with a minimal loss. Therefore, the turbine performance can be improved.

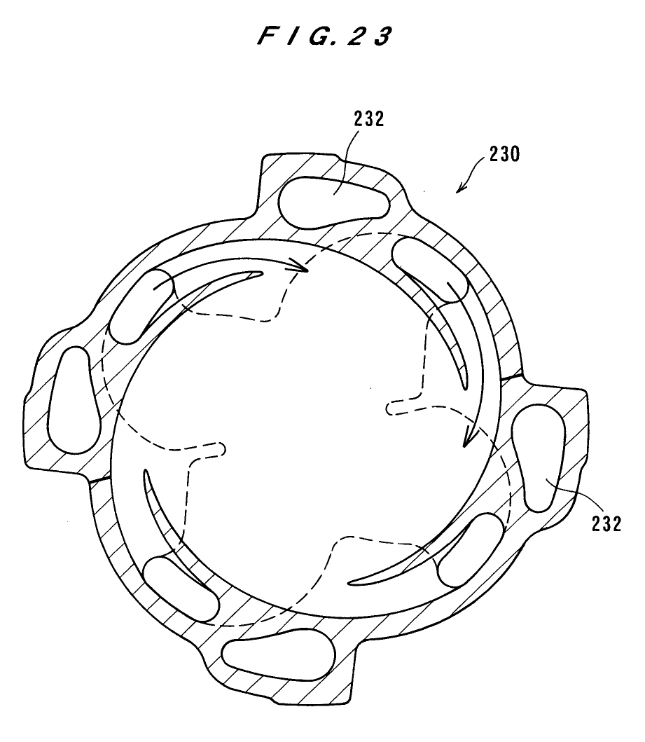

Instead of the radial nozzle 222, a multiple volute nozzle 230 shown in FIG. 23 may be provided. The multiple volute nozzle 230 has a plurality of volute channels 232 extending radially and spirally, and is disposed near the peripheral inlets of the runner 16. The multiple volute nozzle 230 can also allow the working fluid to form a straight meridional flow running radially. Further, a distance between the outlets of the multiple volute nozzle 230 and the inlets of the runner 16 can be set short. Accordingly, the runner 16 can receive energy of the flow from the multiple volute nozzle 230 with a minimal loss, and hence the turbine performance can be improved. Further, since the multiple volute nozzle 230 has the plurality of volute channels 232, a radial fluid force becomes smaller than single volute nozzle.

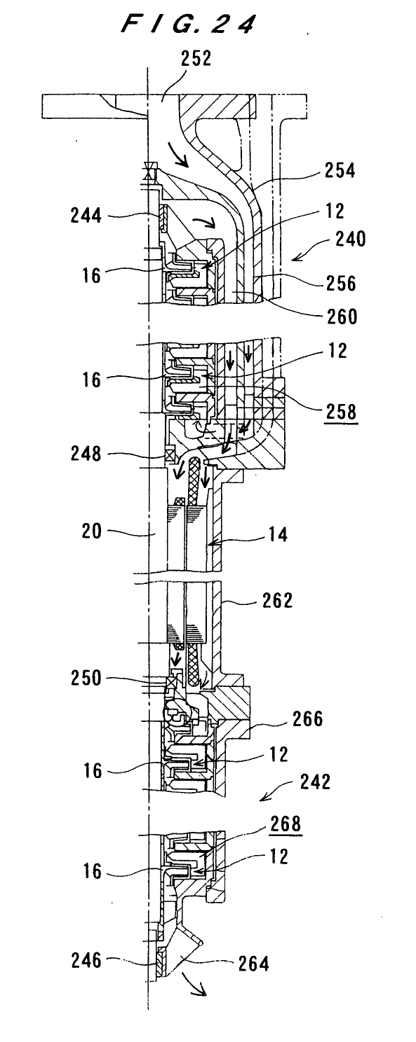

FIG. 24 shows a submerged turbine generator according to still another embodiment of the present invention. The submerged turbine generator of this embodiment comprises a first multistage turbine group 240 having a plurality of turbine stages 12 arranged in series so as to face the same direction (facing upward), and a second multistage turbine group 242 having a plurality of turbine stages 12 arranged in series so as to face the opposite direction of the turbine stages 12 of the first multistage turbine group 240 (i.e., facing downward). The first multistage turbine group 240 is located above the generator 14, and the second multistage turbine group 242 is located below the generator 14. The rotor 18 of the generator 14 and the runners 16 of the turbine stages 12 are fixed to the shaft 20, which is rotatably supported by an upper bearing 244, a lower bearing 246, an upper generator bearing 248, and a lower generator bearing 250.

The turbine stages 12 of the first multistage turbine group 240 are housed in a first casing 254 having a fluid inlet 252 at its upper end. The high-pressure working fluid is introduced into the first casing 254 through the fluid inlet 252, flows downwardly through a first fluid passage 256 formed in the first casing 254, and flows upwardly through a first main passage 258 formed between the turbine stages 12 and the first casing 254 to thereby rotate the turbine stages 12 of the first multistage turbine group 240. Then, the working fluid flows downwardly through a second fluid passage 260. The generator 14 is housed in a housing 262 communicating with the second fluid passage 260. After flowing downwardly through the second fluid passage 260, the working fluid flows through the inside of the housing 262 to cool the generator 14. The turbine stages 12 of the second multistage turbine group 242 are housed in a second casing 266 communicating with the inside of the housing 262 and having a fluid outlet 264 at its lower end. After passing through the housing 262, the working fluid flows downwardly through a second main passage 268 formed between the turbine stages 12 and the second casing 266 to thereby rotate the turbine stages 12 of the second multistage turbine group 242. The working fluid is then discharged to the exterior of the turbine generator through the fluid outlet 264.

Generally, in the multistage turbine having a plurality of turbine stages facing the same direction, a force is produced due to an axial fluid force and a fluid pressure. This force acts as a thrust load to increase the load exerted on the bearings. According to this embodiment, the opposed multistage turbine groups 240 and 242, each having the same number of stages, can cancel the thrust load generated in the turbine generator. For example, if the multistage turbine has six stages, it comprises three turbine stages facing one direction, and three turbine stages facing the opposite direction. In the horizontal turbine generator, the arrangement of the opposed multistage turbine groups can completely cancel the thrust load. In the vertical turbine generator, in order to generate an upward force corresponding to the weight of the rotating assembly (i.e., the shaft, the rotor, and the runners) during normal operation, the number of upwardly facing runners (i.e., the runners having the upwardly facing outlets) may be appropriately increased, and/or the diameter of the wearing rings may be adjusted. By appropriately adjusting the number of upwardly facing runners and/or the diameter of the wearing rings, the thrust load can be cancelled during normal operation, and hence the life of the bearings can increase.

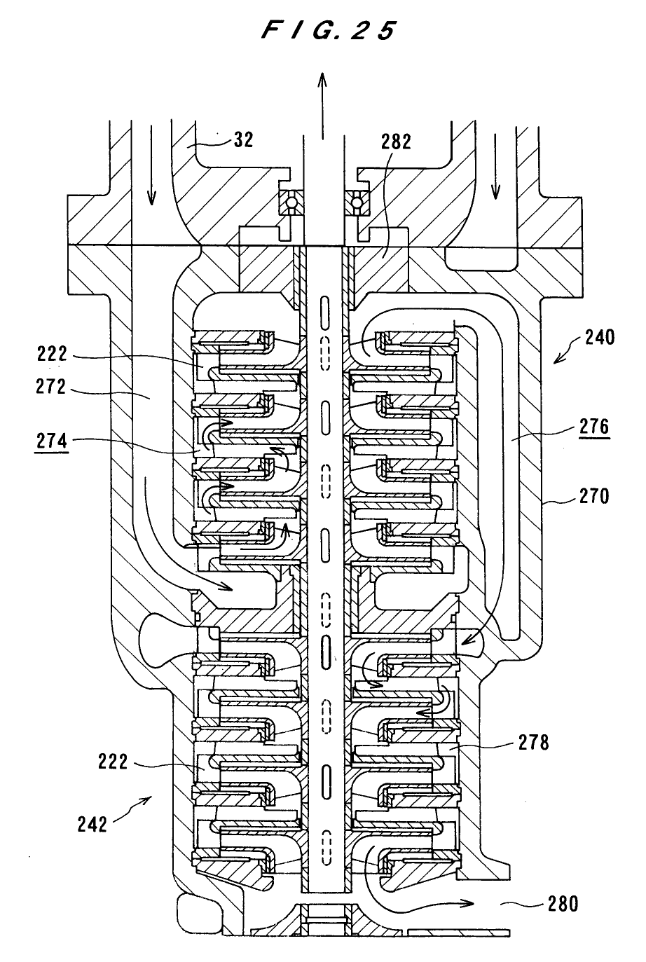

As shown in FIG. 25, the first multistage turbine group 240 and the second multistage turbine group 242 may be disposed at one side (e.g., a lower side) of the generator 14. In this case, the first multistage turbine group 240 and the second multistage turbine group 242 are adjacent to each other, and are housed in a single casing 270. The high-pressure working fluid supplied from the working fluid source 22 (see FIG. 1) flows downwardly through a first fluid passage 272 formed in the casing 270, and flows upwardly through a first main passage 274 formed between the turbine stages 12 and the casing 270 to thereby rotate the turbine stages 12 of the first multistage turbine group 240. Then, the working fluid flows downwardly through a second fluid passage 276 into a second main passage 278 formed between the casing 270 and the turbine stages 12 of the second multistage turbine group 242. The working fluid flows downwardly through the second main passage 278 to thereby rotate the turbine stages 12 of the second multistage turbine group 242, and is then discharged to the exterior of the turbine generator through a fluid outlet 280.

In this example, the radial nozzles 222 shown in FIGS. 21 and 22 are disposed near the peripheral inlets of the runners 16 of the turbine stages 12. Further, in this example, the high-pressure working fluid supplied to the first multistage turbine group 240 is introduced into the housing 32 through a balance drum 282.

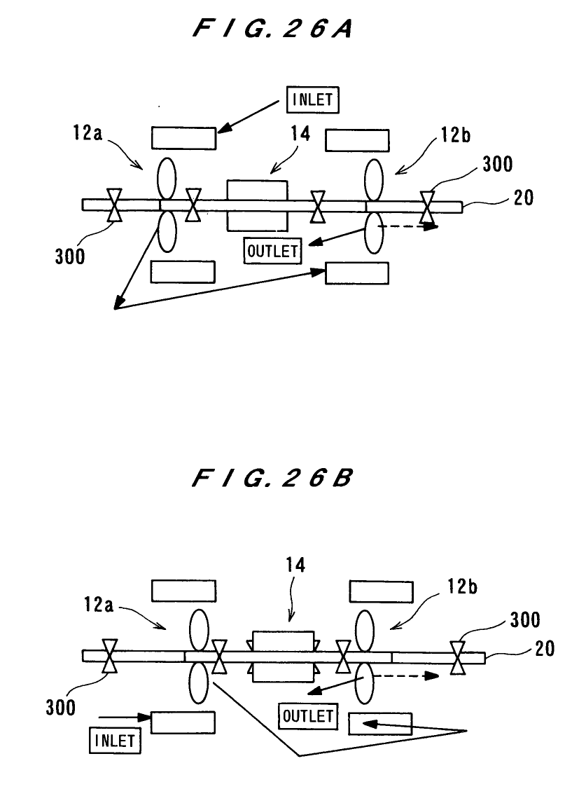

As schematically shown in FIG. 26A, a turbine stage 12a and a turbine stage 12b (or turbine stages 12a and turbine stages 12b), which face opposite directions, may be disposed so that the generator 14 is interposed therebetween. In this example, the turbine stage (or turbine stages) 12a and the turbine stage (or turbine stages) 12b, which respectively form a first turbine group and a second turbine group, are fixed to the shaft 20, which is rotatably supported by a plurality of bearings 300. As shown FIG. 26A, a leftward flow of the working fluid rotates the left-side turbine stage (or turbine stages) 12a, and then a rightward flow of the working fluid rotates the right-turbine stage (or turbine stages) 12b. As shown in FIG. 26B, a rightward flow of the working fluid may rotate the left-side turbine stage (or turbine stages) 12a, and then a leftward flow of the working fluid may rotate the right-side turbine stage (or turbine stages) 12b.

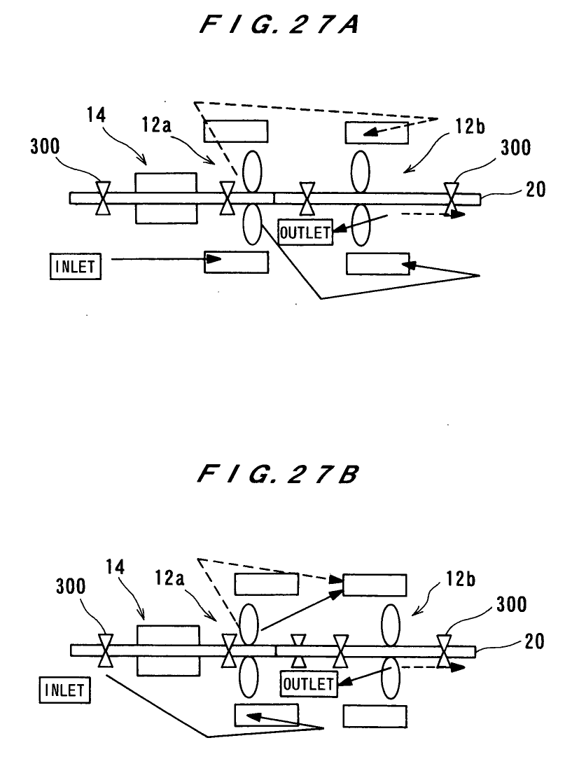

As schematically shown in FIG. 27A, a turbine stage 12a and a turbine stage 12b (or turbine stages 12a and turbine stages 12b), which face opposite directions, may be disposed at one side of the generator 14. In this example, the turbine stages 12a and 12b are fixed to the shaft 20, which is rotatably supported by a plurality of bearings 300. As shown FIG. 27A, a rightward flow of the working fluid rotates the left-side turbine stage (or turbine stages) 12a, and then a leftward flow of the working fluid rotates the right-side turbine stage (or turbine stages) 12b. As shown in FIG. 27B, a leftward flow of the working fluid may rotate the left-side turbine stage (or turbine stages) 12a, and then a rightward flow of the working fluid may rotate the right-side turbine stage (or turbine stages) 12b.

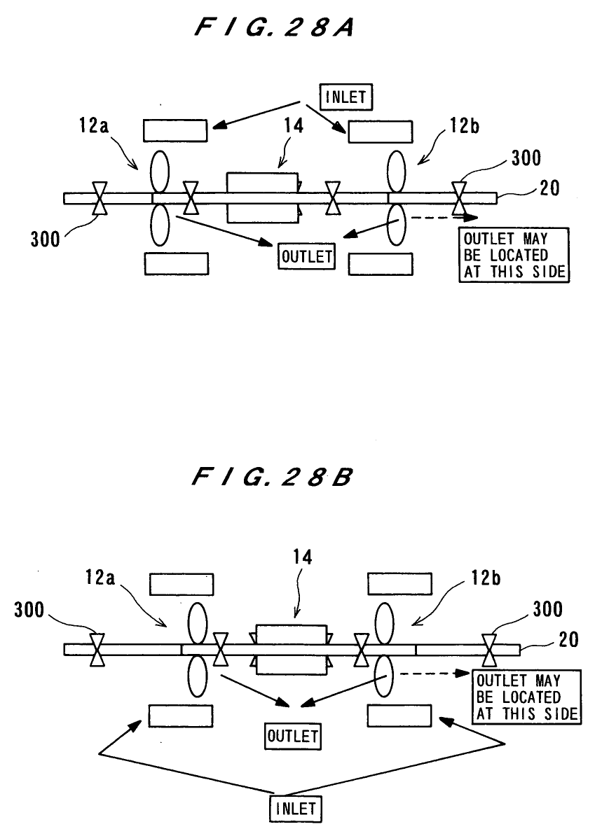

FIG. 28A shows a schematic view showing a submerged turbine generator according to still another embodiment of the present invention. In this embodiment, a turbine stage 12a and a turbine stage 12b (or turbine stages 12a and turbine stages 12b), which face opposite directions, are disposed so that the generator 14 is interposed therebetween. The turbine stage (or turbine stages) 12a and 12b are fixed to the shaft 20, which is rotatably supported by a plurality of bearings 300. The high-pressure working fluid is supplied from the working fluid source 22 (see FIG. 1) into a casing (not shown) in which the turbine stage (or turbine stages) 12a and 12b are housed. Specifically, the working fluid is supplied simultaneously to the turbine stage (or turbine stages) 12a and 12b in such a manner that two opposed flows of the working fluid simultaneously move outwardly from the generator 14 along the axial direction of the shaft 20. These two flows of the working fluid simultaneously rotate the turbine stage (or turbine stages) 12a and 12b to thereby rotate the shaft 20.

Generally, a runaway speed is determined by the shape of the path formed in the runner. According to this embodiment, a flow rate can be doubled while maintaining the shape of the path of the runner as it is. Specifically, the flow rate can be doubled while the runaway speed is kept low. Accordingly, this embodiment can provide a high flow rate submerged turbine generator which is safe in terms of the centrifugal stress. Further, according to this embodiment, the axial fluid force can be cancelled.

As schematically shown in FIG. 28B, the high-pressure working fluid may be supplied from the working fluid source 22 (see FIG. 1) to the casing (not shown) such that the two opposed flows simultaneously move inwardly toward the generator 14 along the axial direction of the shaft 20. In this case also, the working fluid is supplied simultaneously to the turbine stage (or turbine stages) 12a and 12b, and the two flows of the working fluid simultaneously rotate the turbine stage (or turbine stages) 12a and 12b to thereby rotate the shaft 20.

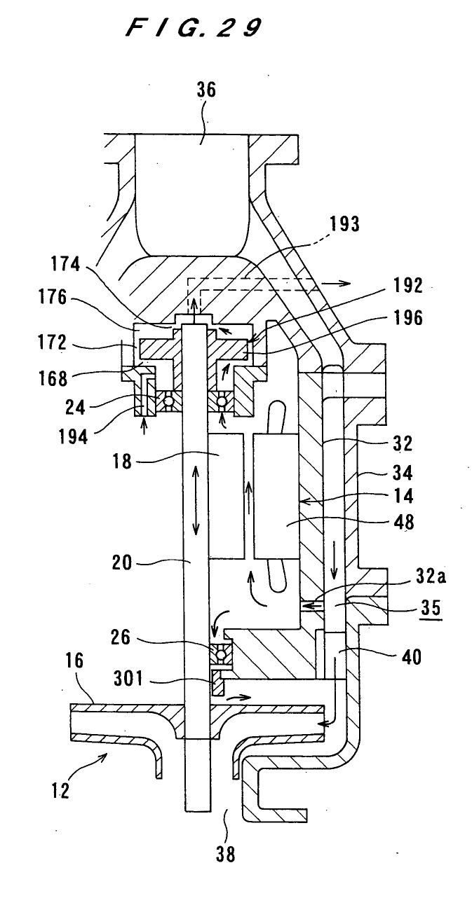

FIG. 29 shows a submerged turbine generator according to still another embodiment of the present invention. This embodiment is different from that shown in FIG. 15 in the following points. A cooling liquid inlet 32a is provided in the housing 32 so that a part of the working fluid in the casing 34 is introduced into the housing 32 through the cooling liquid inlet 32a. A fixed sleeve 301 is provided below the lower bearing 26 so that a fixed orifice is formed between the fixed sleeve 301 and the shaft 20. The high-pressure working fluid introduced into the housing 32 serves to cool the generator 14 and the bearings 24 and 26.

If the working fluid having a reduced pressure is introduced into the housing 32 so as to cool the generator 14, the working fluid is likely to be evaporated due to heat loss of the generator 14, resulting in insufficient cooling of the generator 14. According to this embodiment, because a part of the high-pressure working fluid is introduced into the housing 32 to cool the generator 14, the working fluid is hardly evaporated and can thus sufficiently cool the generator 14. In order to prevent foreign materials from entering the housing 32, a filter may be attached to the cooling liquid inlet 32a.

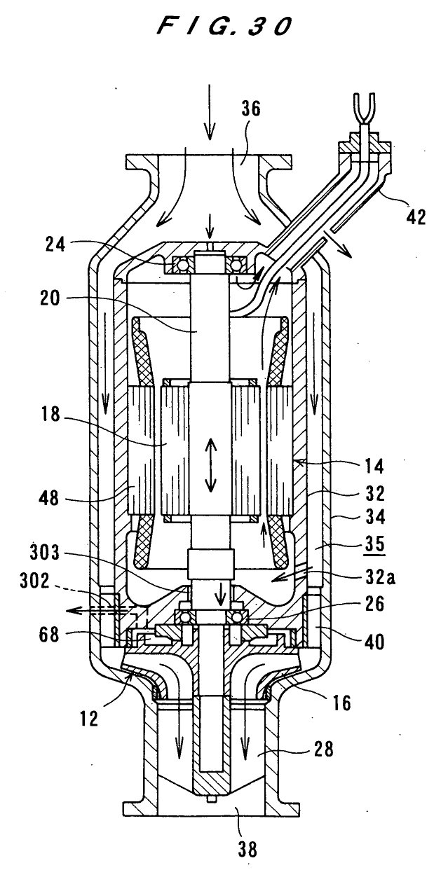

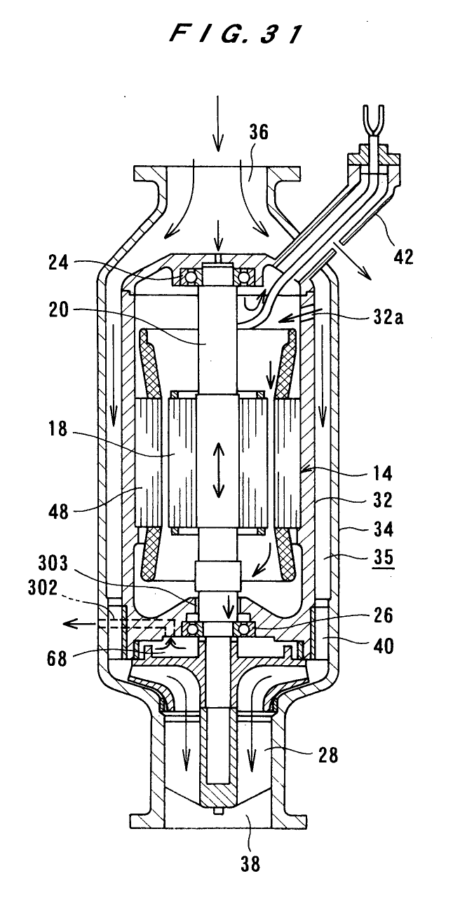

FIG. 30 shows a submerged turbine generator according to still another embodiment of the present invention. This embodiment is different from that shown in FIGS. 1 through 4 in the following points. A passage 302 is provided so that the working fluid in the above-mentioned variable pressure chamber 68 is released to the exterior of the turbine generator through the passage 302. A fixed orifice 303 is formed between the housing 32 and the shaft 20 at a position above the lower bearing 26. The cooling liquid inlet 32a is provided in the housing 32 so that a part of the high-pressure working fluid in the casing 34 is introduced into the housing 32 to cool the generator 14.

Although the cooling liquid inlet 32a is located below the generator 14 in this embodiment as shown in FIG. 30, the cooling liquid inlet 32a may be located above the generator 14 as shown in FIG. 31.

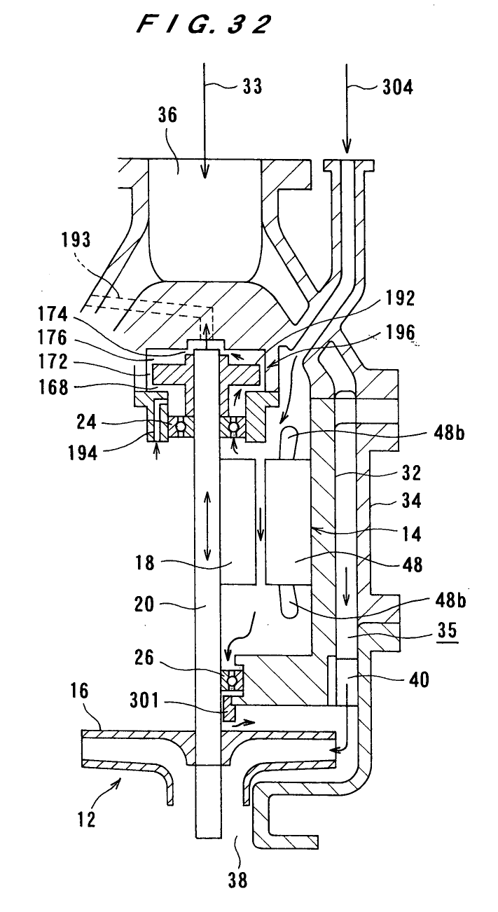

FIG. 32 shows a submerged turbine generator according to still another embodiment of the present invention. This embodiment is different from that shown in FIG. 29 in the following points. A secondary line 304 through which the high-pressure working fluid is supplied into the housing 32 is provided, in addition to the main line 33 through which the high-pressure working fluid is supplied from the working fluid source 22 (see FIG. 1) to the main passage 35 formed between the housing 32 and the casing 34. The high-pressure working fluid is supplied into the housing 32 through the secondary line 304 to cool the generator 14.

Generally, if the working fluid passes through the turbine 12 and then flows into the housing 32, foreign materials may enter the housing 32. According to this embodiment, the secondary line 304 is provided separately from the main line 33 so that the working fluid is independently delivered to the housing 32. Therefore, the foreign materials can be prevented from entering the housing 32. In this case, it is preferable to provide a filter or a strainer in the secondary line 304 so as to effectively prevent the foreign materials from entering the housing 32. Further, according to this embodiment, because the high-pressure working fluid is introduced into the housing 32, an internal pressure of the housing 32 increases to such a degree that the working fluid is hardly evaporated. The secondary line 304 may serve as both a cooling line and a bearing lubrication line. Specifically, the working fluid may lubricate the bearings 24 and 26 and then cool the generator 14. The reverse is also possible. The working fluid may be supplied to the sides of coil ends 48b of the stator 48.

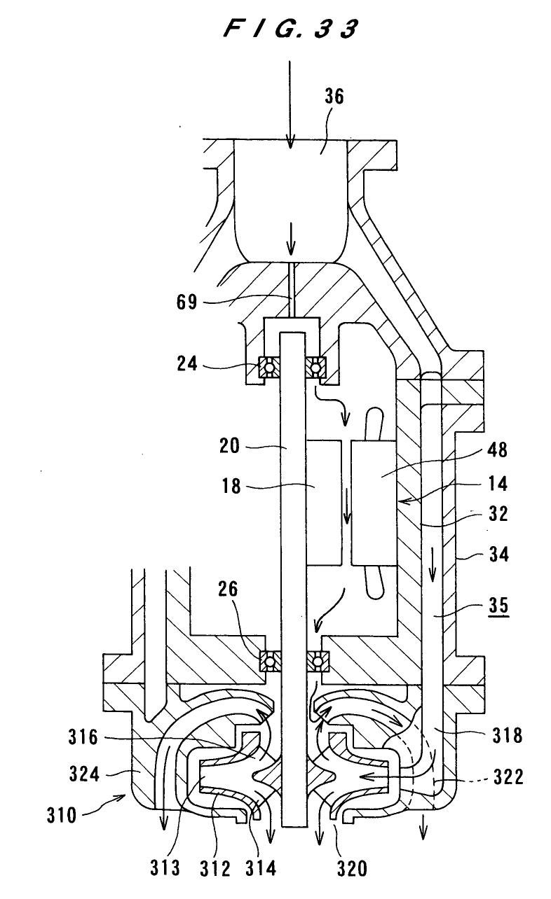

FIG. 33 shows a submerged turbine generator according to still another embodiment of the present invention. This embodiment is different from that shown in FIGS. 1 through 4 in the following points. The submerged turbine generator does not comprise the thrust balancing mechanism. As with the previously described embodiments, the rotor 18 of the generator 14 is fixed to the shaft 20, which is rotatably supported by the upper bearing 24 and the lower bearing 26. Both the upper bearing 24 and the lower bearing 26 may be a ball bearing. The submerged turbine generator of this embodiment comprises a turbine 310 having a runner 312 which is a so-called double discharge runner. The runner 312 has a single inlet 313 through which the working fluid is introduced, and a first outlet 314 and a second outlet 316 through which the working fluid is discharged. The working fluid is divided by flowing through the first outlet 314 and the second outlet 316 into two opposed flows, which move away from each other along the axial direction of the shaft 20. The runner 312 is housed in a turbine casing 324, and is fixed to the shaft 20. The turbine casing 324 has an inlet passage 318 and two outlet passages 320 and 322. The inlet passage 318 communicates with the main passage 35 formed between the housing 32 and the casing 34. The turbine casing 324 is fixed to the casing 34.

With this configuration, the working fluid is supplied to the runner 312 through the main passage 35 and the inlet passage 318. The working fluid flows into the inlet 313, passes through the runner 312, and is discharged through the first outlet 314 and the second outlet 316, thereby rotating the runner 312 together with the shaft 20.

Generally, a centrifugal runner has a low runaway speed compared with a mixed flow type and an axial flow type during no-road running, and is advantageous in reducing centrifugal stress. However, if the centrifugal runner is designed to deliver a fluid at a high flow rate, the shape of the runner should be of the mixed flow type. Therefore, there is a limit in increasing the flow rate under the condition of the reduced centrifugal stress.

According to this embodiment, because the runner 312 has the single inlet 313 and the first and second outlets 314 and 316 through which the working fluid is discharged to form the two flows moving away from each other along the axial direction of the shaft 20, the flow rate can be doubled while maintaining the shape of the path of the runner 312, which determines the runaway speed, as it is. Specifically, the flow rate can be doubled while the runaway speed is kept low. Accordingly, this embodiment can provide a high flow rate submerged turbine generator which is safe in terms of the centrifugal stress. Further, according to this embodiment, the axial fluid force can be cancelled. In the vertical turbine generator, the diameter of the wearing rings near the first and second outlets 314 and 316 may be adjusted so as to generate an axial fluid force which can cancel the weight of the rotor 18. By appropriately adjusting the diameter of the wearing rings, the thrust load can be balanced during design speed operation, whereby the bearings can have a longer life.

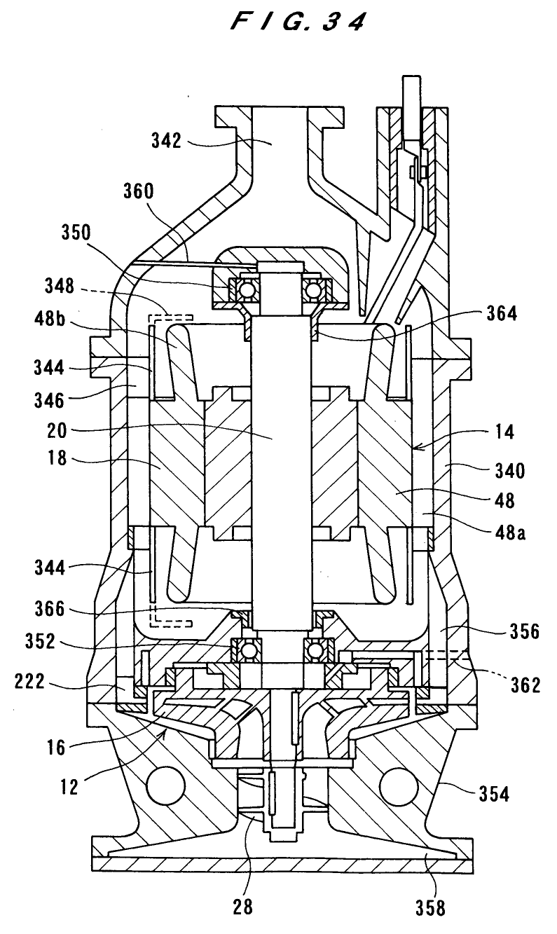

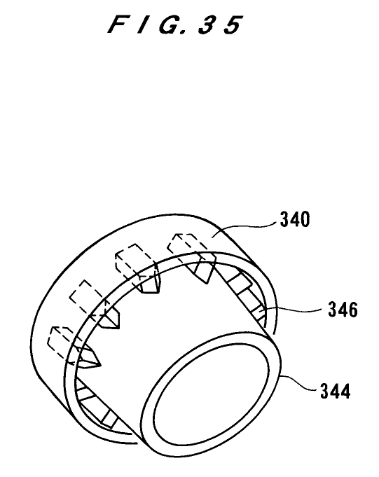

FIG. 34 shows a submerged turbine generator according to still another embodiment of the present invention. The submerged turbine generator of this embodiment comprises a housing 340 in which the generator 14 is housed. The housing 340 is connected to the working fluid source 22 (see FIG. 1) through an inlet 342. All of the working fluid supplied from the working fluid source 22 for rotating the turbine 12 is led into the housing 340 to cool the generator 14.

A plurality of channels 48a, which axially extend through the stator 48 in the axial direction of the shaft 20, are formed on the outer circumferential surface of the stator 48 at equal intervals along the circumferential direction of the stator 48. From a standpoint of cooling effect and manufacturing efficiency, the channels 48a are preferably provided inside the stator 48 or on the outer circumferential surface of the stator 48 in the axial direction of the shaft 20. In terms of strength, the channels 48a should preferably have a substantially circular cross section. On the other hand, in terms of cooling effect, the channels 48a should preferably have a rectangular, triangular, or star-shaped cross section, which has a long wetted perimeter. A filter may be attached to a fluid inlet in order to prevent the foreign materials from entering the housing 340.

In this embodiment, cylindrical coil end covers 344 are provided so as to surround the coil ends 48b of the stator 48. As shown in detail in FIG. 35, a plurality of rectifier stays 346 are disposed on the outer circumferential surface of the coil end cover 344 at equal intervals in the circumferential direction of the coil end cover 344. The coil end covers 344 surrounding the coil ends 48b of the stator 48 can protect the coil ends 48b from being exposed to the flow of the working fluid, thus preventing damage to the coil ends 48b. Further, the stays 346 can condition the flow of the working fluid running along the outer circumferential surfaces of the coil end covers 344.

As indicated by imaginary lines shown in FIG. 34, the end surfaces of the coil ends 48b may be covered with caps 348 attached to the end portions of the coil end covers 344. Such a structure can further prevent the damage to the coil ends 48b of the stator 48.

The rotor 18 of the generator 14 is fixed to the shaft 20, which is rotatably supported by an upper bearing 350 and a lower bearing 352. The runner 16 is fixed to the end portion of the shaft 20, and the exducer 28 is disposed below the runner 16. The runner 16 and the exducer 28 are enclosed by a turbine casing 354. A main passage 356 is provided in the housing 340 at the side of the turbine casing 354. The working fluid flows through the housing 340, the main passage 356, the runner 16, and the exducer 28, and is then discharged to the exterior of the turbine generator through an outlet 358 of the turbine casing 354. The radial nozzle 222 shown in FIGS. 21 and 22 is disposed near the peripheral inlets of the runner 16.

A part of the working fluid enters a region above the upper bearing 350, and is discharged to the exterior of the turbine generator through a first relief line 360. A part of the working fluid also enters a region below the lower bearing 352, and is discharged to the exterior of the turbine generator through a second relief line 362. Accordingly, a differential pressure is not created in the axial direction of the shaft 20, and hence the thrust force is prevented from being generated.

In this embodiment, in order to further reduce a pressure developed at the turbine-inlet-side end portion of the shaft 20, a bush-like annular ring 364 and a bush-like annular ring 366 are provided near the upper bearing 350 and the lower bearing 352, respectively. The annular ring 364 serves to prevent the working fluid from entering the upper bearing 350, and the annular ring 366 serves to prevent the working fluid from entering the lower bearing 352. Only one of the annular bearings 364 and 366 may be provided, or both may be eliminated.

If the working fluid having a low pressure is introduced into the housing 340 so as to cool the generator 14, the working fluid is likely to be evaporated due to heat loss of the generator 14, resulting in insufficient cooling of the generator 14. According to this embodiment, because the high-pressure working fluid (turbine inlet flow) is introduced into the housing 340 so as to cool the generator 14, the working fluid is hardly evaporated in the housing 340 and can thus sufficiently cool the generator 14. Further, because all of the working fluid used to rotate the turbine 12 flows around the generator 14, an average temperature of the working fluid does not increase to so high a level, and hence the working fluid can be further prevented from being evaporated in the housing 340.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims and equivalents.

What is claimed is:

1. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor; and
bearings for rotatably supporting said shaft;
wherein said shaft includes at least two members.

2. The submerged turbine generator according to claim 1, wherein said at least two members of said shaft comprise:
a generator-side shaft to which said rotor is fixed; and
a turbine-side shaft to which said runner is fixed;
wherein said generator-side shaft and said turbine-side shaft are coupled to each other in series.

3. The submerged turbine generator according to claim 1, wherein:
said at least two members of said shaft comprise a solid shaft, and a sleeve shaft surrounding said solid shaft;
said rotor is fixed to an outer circumferential surface of said sleeve shaft; and
said runner is fixed to a circumferential surface of said solid shaft.

4. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor;
a thrust balancing mechanism operable to balance a thrust load applied to said shaft; and
bearings for rotatably supporting said shaft;
wherein at least one of said bearings comprises a thrust magnetic bearing operable to support the thrust load applied to said shaft at rest and start-up.

5. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor; and
bearings for rotatably supporting said shaft;
wherein each of said bearings comprises a contact bearing section and a non-contact bearing section.

6. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor;
bearings for rotatably supporting said shaft;
a main line through which the working fluid is delivered to said runner; and
a secondary line through which the working fluid is delivered to cool said bearings.

7. A submerged turbine generator, comprising:
a shaft;
a casing;
a turbine having a runner fixed to a first end of said shaft so that said runner is rotated integrally with said shaft due to pressure of a working fluid introduced into said casing;
a generator having a rotor fixed to said shaft and a stator surrounding said rotor;
a thrust balancing mechanism operable to balance a thrust load applied to said shaft, said thrust balancing mechanism comprising a fixed orifice and a variable orifice; and
bearings for rotatably supporting said shaft;
wherein said fixed orifice and/or said variable orifice of said thrust balancing mechanism is disposed at a second end of said shaft opposite to said first end.

8. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor;
a housing in which said generator is housed;
a thrust balancing mechanism operable to balance a thrust load applied to said shaft; and
bearings for rotatably supporting said shaft;
wherein said thrust balancing mechanism comprises a balance sleeve fixed to said shaft and arranged to form a fixed orifice and/or a variable orifice with said housing.

9. The submerged turbine generator according to claim 8, wherein both a fixed orifice and a variable orifice are formed between said balance sleeve and said housing.

10. The submerged turbine generator according to claim 8, wherein said thrust balancing mechanism has a variable orifice located between said shaft and said housing.

11. The submerged turbine generator according to claim 8, wherein said thrust balancing mechanism has a variable orifice located between said runner and said housing.

12. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor;
a thrust balancing mechanism operable to balance a thrust load applied to said shaft; and
bearings for rotatably supporting said shaft;
wherein said thrust balancing mechanism comprises a balance piston fixed to said shaft.

13. A submerged turbine generator, comprising:
a shaft;
a casing;
a multistage turbine having a plurality of runners fixed to said shaft so that said runners are rotated integrally with said shaft due to pressure of a working fluid introduced into said casing;
a generator having a rotor fixed to said shaft and a stator surrounding said rotor; and
bearings for rotatably supporting said shaft;
wherein said multistage turbine comprises a first turbine group and a second turbine group which are arranged so as to face opposite directions.

14. A submerged turbine generator, comprising:
a shaft;
a casing;
a plurality of turbine stages each having a runner fixed to said shaft so that said runner of each of said plurality of turbine stages is rotated integrally with said shaft due to pressure of a working fluid introduced into said casing;
a generator having a rotor fixed to said shaft and a stator surrounding said rotor; and
bearings for rotatably supporting said shaft;
wherein said plurality of turbine stages comprise a first turbine group and a second turbine group which are arranged so as to face opposite directions; and
wherein said first turbine group and said second turbine group are arranged so as to simultaneously receive the working fluid to thereby simultaneously rotate said plurality of turbine stages.

15. The submerged turbine generator according to claim 14, wherein said plurality of turbine stages are shaped and arranged so as to allow the working fluid to form two flows moving in opposite directions to thereby simultaneously rotate said plurality of turbine stages.

16. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor; and
a housing in which said generator is housed, said housing having bearings for rotatably supporting said shaft;
wherein said housing has a cooling liquid inlet through which a part of the working fluid in said casing is introduced into said housing.

17. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor;
a housing in which said generator is housed, said housing having bearings for rotatably supporting said shaft;
a main line through which the working fluid is delivered into said casing; and
a secondary line through which the working fluid is delivered into said housing.

18. A submerged turbine generator, comprising:
a shaft;
a turbine having a runner fixed to said shaft so that said runner is rotated integrally with said shaft due to pressure of a working fluid;
a generator having a rotor fixed to said shaft and a stator surrounding said rotor;
a housing in which said generator is housed; and
bearings for rotatably supporting said shaft;
wherein the working fluid is supplied into said housing, flows around said generator, and then rotates said runner.

19. The submerged turbine generator according to claim 18, further comprising a coil end cover surrounding a coil end of said stator.

20. The submerged turbine generator according to claim 19, wherein a plurality of stays are provided on an outer circumferential surface of said coil end cover.

21. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor; and
bearings for rotatably supporting said shaft;
wherein said runner has a single inlet, a first outlet, and a second outlet to allow the working fluid to form two flows moving away from each other along an axial direction of said shaft.

22. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor;
bearings for rotatably supporting said shaft; and
a radial nozzle disposed near peripheral inlets of said runner.

23. A submerged turbine generator, comprising:
a shaft;
a casing;
a turbine having a runner fixed to said shaft so that said runner is rotated integrally with said shaft due to pressure of a working fluid introduced into said casing;
a generator having a rotor fixed to said shaft and a stator surrounding said rotor;
bearings for rotatably supporting said shaft; and
a multiple volute nozzle disposed near peripheral inlets of said runner.
